(19) United States
(12) Patent Application Publication
(10) Pub. No.: US 2015/0215762 A1
(43) Pub. Date: Jul. 30, 2015

(54) METHOD AND APPARATUS FOR VERIFYING THE IDENTITY OF A WIRELESS DEVICE

(71) Applicant: QUALCOMM Incorporated, San Diego, CA (US)

(72) Inventor: Stephen William Edge, Escondido, CA (US)

(21) Appl. No.: 14/603,337

(22) Filed: Jan. 22, 2015

Related U.S. Application Data
(60) Provisional application No. 61/931,532, filed on Jan. 24, 2014.

(51) Int. Cl. H04W 8/00

(52) U.S. Cl. CPC H04W 8/005; H04W 84/12

(57) ABSTRACT

A method, device, computer program product, and apparatus for verifying the identity (ID) of a wireless device are described. The ID and a first measurement of a trusted access point (AP) are received from the wireless device. A second measurement from the trusted AP is received, where the second measurement is of a signal comprising the ID. To verify the ID, consistency of the first and second measurements is verified.

### CROSS-REFERENCE TO RELATED APPLICATIONS

This application claims the benefit of U.S. Provisional Patent Application Ser. No. 61/931,532, filed on Jan. 24, 2014, entitled, “VERIFYING THE IDENTITY OF A WIRELESS DEVICE,” which is herein incorporated, in its entirety, by reference.

### FIELD

The subject matter disclosed herein relates generally to wireless device identification verification.

### BACKGROUND

For a device in communication with wireless access points (APs), measurement of Wi-Fi signals (e.g., IEEE 802.11x standards) can be utilized by the device or by a location server to derive position information for the device (e.g., a latitude and longitude). Conventional network based positioning (NBP) techniques may utilize measurements such as Received Signal Strength Indication (RSSI), Angle Of signal Arrival (AOA) and Round Trip signal propagation Time (RTT) measurements derived from radio frequency (RF) Wi-Fi signals transmitted from the device. For example, with NBP, signals received from a device by one or more APs in a network of APs may be measured by the APs and used (e.g., by a location server that can access the measurements from the APs) to determine a location for the device. An AP can be a device that allows wireless devices to connect to a wired network using Wi-Fi, or other wireless standards. Utilizing NBP measurement techniques to accurately determine the position of a device typically involves obtaining measurement information from APs nearby to the device. NBP methods involving Wi-Fi APs typically rely on being able to correctly identify a target device using the device MAC address that is present in Wi-Fi frames transmitted by the device. However, a MAC address is not always a reliable means of identifying a device as a MAC address may be deliberately falsified by a process known as spoofing.

As an example of spoofing, a device (e.g., a fixed or mobile device) “A” may masquerade as another device “B”. Device “A” may access a location service for a venue such as a shopping mall or airport (e.g., may access a location server (LS) in the venue) that provides location services to devices in the venue. Location services may provide an estimate of the current location of any device to that particular device. Location services may also provide a map (e.g., a floor plan) of the venue to the device with the current position of the device indicated on the map. Device “A” can provide the MAC address of the device “B” to the location service (e.g., to an LS or to an application server such as a location based services (LBS) application server (AS) for the In Location Alliance (ILA) architecture). For example, device “A” or the user of device “A” may discover the MAC address of device “B” by monitoring Wi-Fi transmissions nearby to device “B” over a period of time (e.g. an hour) and observing a common MAC address being transmitted as device “B” moves between different locations. Alternatively or in addition, device “A” may employ ranging measurements (e.g., of RSSI or RTT) to measure ranges to nearby Wi-Fi devices and may associate the MAC address for device “B” with the MAC address whose measured range corresponds to a known estimated range from device “A” to device “B”. The MAC address for device “B” can be provided to the location service as purporting to belong to the device “A”. For example, the MAC address could be provided to an LS for the venue location service using some higher level protocol such as the User plane Location Protocol (ULP) defined by the Open Mobile Alliance

Device “A” (e.g. the user of device “A”) may intend to track the location of device “B” (e.g. the user of device “B”) by means of NBP supported by the venue location service in one venue or in a set of venues. The venue location service (e.g. an LS or LBS AS for the location service) may be able to authenticate another identity for the device “A” such as a user ID or an International Mobile Subscriber Identity (IMSI) and may thereafter assume that device “A” is trustworthy. If device “A” then provides the MAC address of device “B” as if the address belongs to device “A”, the location service (e.g. an LS and/or LBS AS) may just assume that this is correct and may then proceed to locate device “B” using the MAC address of device “B” provided by device “A” and subsequently return the location of device “B” to device “A”—leading to unauthorized tracking of device “B” by device “A”. The venue may employ NBP to track the location of device “B” using the MAC address provided by device “A” assuming that this location will correspond to that for device “A” and thereby not infringe the privacy of another user. Such spoofing may be possible if the venue is unable to verify that the MAC address provided by device “A” actually belongs to device “A”.

In a different type of spoofing, one device “A” may masquerade as another device “B” by including the MAC address of device “B” in IEEE 802.11 Wi-Fi frames transmitted by device “A”. Any location derived from measurements of such frames using NBP in a venue may then incorrectly ascribe the location to device “B”, which may allow a device “A” to spoof incorrect locations for the device “B” to some client who wants to know the current location of device “B”. For example, this type of spoofing could be used to falsely locate the user of device “B” at a location remote from the real location of the user of device “B” which could then be used for a number of criminal or other nefarious purposes.

Therefore, new and improved identification verification techniques are desirable to enable verification of a MAC address or other address of a device that is visible to access points that support NBP and that may be used to locate a device.

### SUMMARY OF THE DESCRIPTION

Embodiments disclosed herein may relate to a method for verifying an identity (ID) claimed by a wireless device. The method may include receiving the ID and a first measurement from the wireless device. The method may include receiving a second measurement from a trusted access point (AP), where the second measurement is of a signal comprising the ID. The method may further include verifying consistency of the first and second measurements.

Embodiments disclosed herein may relate to a machine readable non-transitory storage medium having stored therein program instructions that are executable by a processor to verify an ID claimed by a wireless device. The storage medium may include instructions to receive the ID and a first measurement from the wireless device. The storage medium may also include instructions to receive a second measurement from a trusted AP, where the second measurement is of a signal comprising the ID. The storage medium may also include instructions for verifying consistency of the first and second measurements.

Embodiments disclosed herein may relate to an apparatus that includes means for verifying an ID claimed by a wireless device. The apparatus may also include means for receiving the ID and a first measurement from the wireless device. The apparatus may also include means for receiving a second measurement from a trusted AP, where the second measurement is of a signal comprising the ID. The apparatus further includes means for verifying consistency of the first and second measurements.

Embodiments disclosed herein may relate to a device or server including a processor and a storage device configurable to store instructions to verify an ID claimed by a wireless device. The device or server may include instructions to receive the ID and a first measurement from the wireless device. The device or server may also include instructions to receive a second measurement from a trusted AP, where the second measurement is of a signal comprising the ID. The device or server may further include instructions to verify consistency of the first and second measurements.

Other features and advantages will be apparent from the accompanying drawings and from the detailed description.

### BRIEF DESCRIPTION OF THE DRAWINGS

FIG. 1 is a diagram of an exemplary operating environment in which Wireless Device Identification Verification (WDIV) may be practiced;

FIG. 2A is a flow diagram illustrating a method for performing WDIV, in one embodiment;

FIG. 2B is a flow diagram illustrating a method for performing WDIV, in another embodiment;

FIG. 3 is an exemplary illustration of a system for performing WDIV;

FIG. 4 is a flow diagram illustrating a method for performing WDIV, in another embodiment;

FIG. 5 illustrates a flow of messages for FIG. 4, in one embodiment;

FIG. 6 is a flow diagram illustrating a method for performing WDIV, in another embodiment;

FIG. 7 is block diagram illustrating an exemplary device in which embodiments of WDIV may be practiced; and

FIG. 8 is block diagram illustrating an exemplary server in which embodiments of WDIV may be practiced.

### DESCRIPTION

In one embodiment, Wireless Device Identification Verification (WDIV) determines the credibility of a device requesting network based positioning (NBP) within a venue. For example, a device “D” may provide identification comprising a Media Access Control (MAC) address “A” when connecting to a location server or an application server; however, the identification may be spoofed from some other legitimate device. This may allow the device “D” to track the location of the legitimate device. In one embodiment, to determine credibility of the device “D” requesting NBP, WDIV receives another MAC address “B” from the device “D” of an AP within Wi-Fi radio range of the device “D”. WDIV can then compare the received MAC address “B” to a MAC address of a trusted AP within the venue that is able to receive IEEE 802.11 Wi-Fi signals from the device “D” that contain the MAC address “A” claimed by the device “D”. Provided the device “D” reports the MAC address “B” of a trusted AP that is able to receive the MAC address “A” claimed by the device “D”, there would be a high probability that device “D” really is nearby to the trusted AP such that the trusted AP and device “D” can each receive signals from one another. In that case, receipt of the MAC address “A” claimed by the device “D” by the trusted AP provides strong evidence that the device “D” owns (or at least is currently using) the MAC address “A”.

In some embodiments, WDIV utilizes RSSI, AOA and/or RTT measurements to verify a device ID such as an IEEE 802.11 MAC address. For example, WDIV can request RSSI, AOA and/or RTT measurements made by a device of nearby APs using Mobile Based Positioning (MBP) and compare the received RSS, AOA and/or RTT measurements with locally obtained RSSI, AOA and/or RTT measurements for the device obtained by trusted APs and can verify that the two sets of measurements are compatible with one another as described in further detail later herein.

In some embodiments, WDIV utilizes location information obtained from a device requesting NBP. For example, WDIV can request a device provide location measurements to enable a location server for a venue to obtain a location estimate for the device using mobile based positioning (MBP). The location server may then compare the location estimate obtained using MBP to a second location estimate for the device obtained using NBP, from measurements obtained from one or more trusted APs based on a purported MAC address for the device, and may verify that the two location are the same or almost the same.

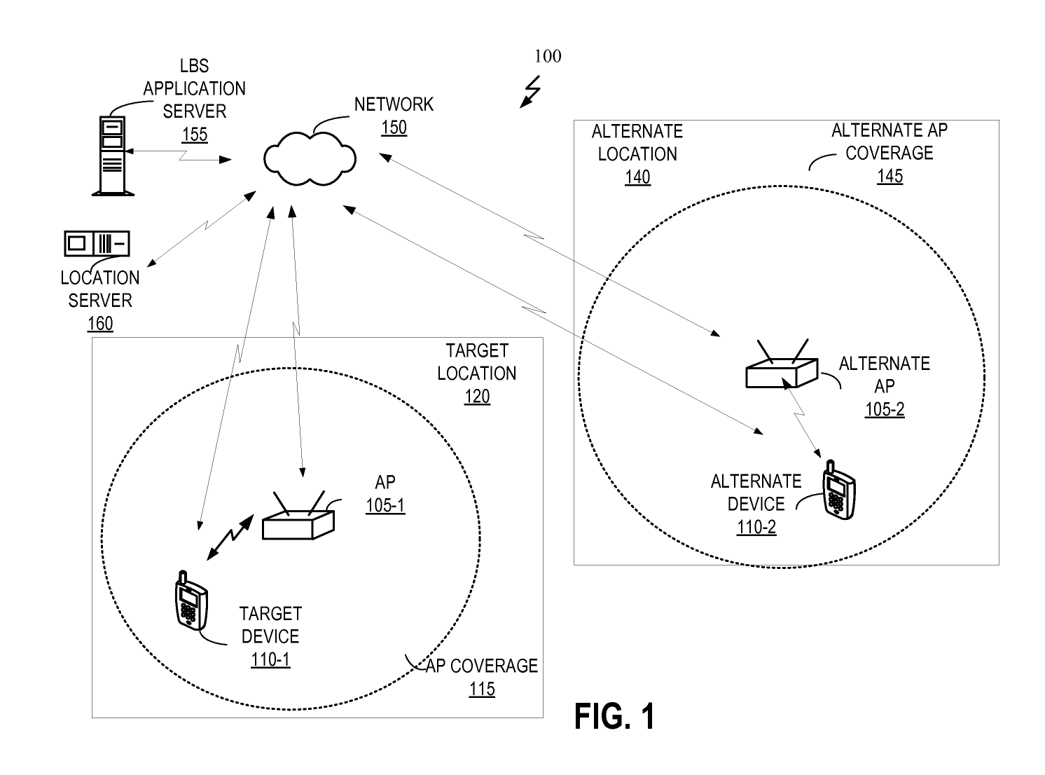

FIG. 1 is a diagram of an exemplary operating environment 100 in which WDIV may be practiced. WDIV may be utilized where an application server (e.g., location based services application server (LBS AS) 155) provides location based services on behalf of a venue (e.g., at target location 120). WDIV may also be utilized where a location server (e.g., location server 160) provides location and positioning information to devices (e.g., to devices 110-1 and 110-2). In one embodiment, logic to perform WDIV may be executed on or integrated into one or more of the location server 160 or application server 155.

In one embodiment, WDIV detects whether a target wireless device requesting NBP is providing a correct ID or an ID belonging to some other wireless device (and thus an incorrect ID). The ID may be an IEEE 802.11 MAC address used for Wi-Fi or could be some other identity or address (e.g. an IP address, an International Mobile Subscriber Identity (IMSI) or an IEEE 802.11 MAC address used for Bluetooth®) that is visible to APs (e.g., AP 105-1 and 105-2) able to receive wireless messages or signals from the target device. A target device (e.g., target device 110-1) may be located within the venue at a target location 120 that provides location services to wireless devices using NBP. An alternate location (e.g., location 140) may also be within the venue but may also be located at a remote location that is not within the venue. A remote or alternate device (e.g., device 110-2) may attempt to spoof the identification (e.g., MAC address) of the target device 110-1. The alternate device 110-2 may be a wireless device or a (non-wireless) computer system (e.g. a PC or laptop) attempting to determine the location and position of the target device 110-1. The alternate device 110-2 may connect to an alternate AP (e.g., AP 105-2) local to the alternate wireless device or may connect via other means (e.g. via a cellular or wireline network such as the Internet). The alternate AP 105-2 and/or the alternate device 110-2 may connect to the location server 160 and/or application server 155 through the network 150.

The terms “wireless device”, “target device”, “target wireless device” and “mobile device” are used interchangeably herein to refer to a communications entity typically associated with a single user that has the ability to communicate wirelessly and that may be portable and/or mobile. The term “device” is used herein to refer to a device that may or may not be a wireless device. A wireless device may be referred to by other names such as a mobile station (MS), a station, a terminal, a target, a wireless terminal, a mobile terminal, a user equipment (UE) or a Secure User Plane Location (SUPL) Enabled Terminal (SET).

The venue for the target location 120 may maintain one or more trusted wireless APs (e.g., AP 105-1) to serve users at the venue (e.g., at target location 120). The trusted AP 105-1 may be part of a Wireless Local Area Network (WLAN), which may operate in a venue such as an office, shopping center, museum, stadium, college campus, airport, hospital, outdoors, or in any other building, building complex, installation or area. Trusted APs may be interconnected to each other, to servers (e.g., location based services application server (LBS AS) 155 and location server 160), and to other wireless devices and devices via the network 150. Network 150 may be a WLAN, a collection of WLANs, a cellular network, a local area network (LAN) or a wireline network that interconnects entities within the venue and may provide access to entities and networks outside the venue (e.g. the Internet). In some embodiments, network 150 may comprise a number of interconnected wireless and/or wireline networks. APs 105-1 and 105-2 may be Wi-Fi APs, Bluetooth APs, femtocells, home base stations, small cells or even base stations supporting pico and macro cells. APs 110-1 and 110-2 may be part of network 150 or separate from network 150 (e.g. part of a WLAN for the venue associated with target location 120). APs 105-1 and 105-2 may support communication using Wi-Fi 802.11x protocols as generally assumed here or may support communication using other or additional wireless technologies such as Long Term Evolution (LTE) or Wideband Code Division Multiple Access (WCDMA) as defined by the 3^{rd} Generation Partnership Project (3GPP) or Bluetooth. APs 105-1 and 105-2 may be fixed (e.g. at known locations) or may (e.g. occasionally) be moved. The WDIV techniques described herein for verifying an address claimed by a wireless device may be used to verify not only MAC addresses for Wi-Fi 802.11x and Bluetooth but also other addresses such as an IP address or IMSI.

When determining the position of a wireless device using a WLAN, a wireless device (e.g., wireless devices 110-1 and 110-2) or a location server (e.g. location server 160) may utilize time of arrival and signal strength techniques. The location server 160 may communicate with wireless devices (e.g. wireless device 110-1) through a network (e.g., network 150) and/or via APs in the WLAN (e.g. via AP 105-1) and may use the communication to: (i) request location information from a wireless device (e.g. a location estimate or location related measurements); (ii) provide assistance data to a wireless device to enable the wireless device to obtain location related measurements (e.g. measurements of signals transmitted by APs) and/or determine a location estimate for the wireless device from location related measurements; and/or (iii) provide a location estimate of the wireless device to the wireless device that was determined by the location server. The position of each AP (e.g. AP 105-1 and/or AP 105-2) in a common coordinate system may be known a-priori and may be stored in the location server 160 (e.g., within a location database). In some embodiments, the position of each AP may not be known but a radio map for each AP may be known (e.g. via calculation or crowdsourcing of measurement data by many wireless devices) that may provide predicted signal characteristics for signals transmitted by the AP such as RSSI and/or RTT at a number of known locations (e.g. locations spaced 1 meter apart in a rectangular grid of locations for the radio coverage area of the AP). In some embodiments, each respective AP can perform measurement techniques (e.g., RSSI and RTT) to determine the AP's position relative to other visible APs and wireless devices in the coverage area of the AP.

In one embodiment, to determine the position of a target device such as target device 110-1, each AP in the venue may transmit signals that may be received by the target device. Each signal may be associated with the signal's originating AP based upon some form of identifying information that may be included in the transmitted signal (e.g., a MAC address for the originating AP). The target device may then perform measurements of RSSI, RTT, AOA, time of arrival (TOA), time difference of arrival (TDOA) compared to signals received from some other AP and/or other characteristics of the received signal. The measurements of signals received from one AP or a number of APs may then be used by the target device to determine a location estimate for the target device using mobile based positioning (MBP) techniques. For example, AOA measurements combined with known positions for the source APs may be used to determine the target device's location using triangulation. Alternatively, RSSI or RTT measurements may be used to determine distances (or ranges) from the target device to source APs with the wireless device location obtained using trilateration. As another alternative, measurements such as of RSSI or RTT obtained for signals transmitted from a number of APs may be compared to a radio map for each AP containing expected values of such characteristics as RSSI or RTT at different known locations with a location for the target device then being determined using a technique known as RF pattern matching. To assist the target device to determine its location using these techniques, a location server such as location server 160 may provide assistance data to the target device containing such information as the exact locations of the source APs, transmission characteristics of the source APs (e.g. transmission power and antenna characteristics) and/or radio maps for the source APs.

In a variant of MBP, known as wireless device assisted MBP, the target device may make location related measurements for signals received from source APs but may transfer the measurements to a location server together with the identity of each source AP (e.g. MAC address) received in the measured signals, following which the location server may determine a location for the target device using the same positioning techniques. Although a target device can make use of signals transmitted by APs (e.g. Wi-Fi APs or Femtocells) to provide a location server with measurements for MPB positioning, signals from other sources can be measured by a target device to support other MBP position methods such as Assisted Global Navigation Satellite System (A-GNSS), in which signals from satellites for such GNSS systems as GPS, Galileo or GLONASS are measured by a target device, or Observed Time Difference Of Arrival (OTDOA), in which time difference between pairs of bases stations (e.g. eNodeBs for LTE) or femtocells (e.g. Home eNodeBs) are measured and reported to a location server.

In another embodiment, to determine the position of a target device such as target device 110-1, each AP in the venue may receive signals that may be transmitted by the target device. The signals may be associated with the target device based upon some form of identifying information that may be included in the transmitted signals (e.g., a MAC address for the target device). A receiving AP may then perform measurements of RSSI, RTT, AOA, TOA, TDOA (e.g. TDOA of signals received from the target device compared to signals received from another AP) and/or other characteristics of the received signal. The measurements of signals transmitted by the target device and received and measured by one AP or by a number of APs may then be used to determine a location estimate for the wireless device using network based positioning (NBP) techniques. For example, the determination may occur at a location server such as location server 160 to which the AP or APs may forward both the measurements and the identification of the target device included in the measured signals. Similar positioning techniques for NBP may be used as for MBP—e.g. AOA measurements may enable location determination using triangulation whereas RSSI and/or RTT measurements may enable location determination using trilateration.

In some embodiments in which MBP or NBP is used, measurement procedures may be used that involve an exchange of signals or messages between an AP and a target device and possibly in which both the AP and the target device obtain measurements. When the final measurements are obtained by the AP (together with an identification of the target device contained in signals transmitted by the target device), the measurements may be used to help obtain the location of the target device using NBP techniques. When the final measurements are obtained by the target device (together with an identification of the AP contained in signals transmitted by the AP), the measurements may be used to help obtain the location of the target device using MBP techniques

With respect to FIG. 1, the dotted circles illustrate respective coverage areas for the trusted AP 105-1 and the alternate AP 105-2. For example, the target device 110-1 is shown as being within the coverage or visible area 115 associated with the trusted AP 105-1. The exemplary coverage areas illustrated in FIG. 1 show symmetrical circles/spheres, however due to obstructions or interference (e.g., walls, or signal blocking objects) the actual coverage area in some embodiments may be entirely asymmetrical.

As illustrated in FIG. 1, an alternate device (e.g., device 110-2) may be located in an alternate location (e.g., location 140) away from the target location 120. The alternate device (e.g., spoofing device) 110-2 may attempt to provide the application server (e.g. LBS AS 155) and/or location server (e.g. LS 160) with the ID (e.g. MAC address) of the target device 110-1 in order to obtain a position or location of the target device 110-1. In one embodiment, WDIV determines the credibility of wireless device IDs by analyzing measurements from wireless devices and APs within the WDIV operating environment 100. For example, WDIV as implemented within the location server 160 can request devices (e.g., devices requesting location services from the location server) to identify one or more nearby APs (e.g., AP MAC addresses). In response to the request for identification of nearby APs, the target wireless device 110-1 can provide WDIV with identification of the trusted AP 105-1, while the alternate (spoofing) device 110-2 provides the identification of the alternate AP 105-2. In response to determining that the identification provided does not match a trusted AP, the alternate device 110-2 may be blocked or otherwise blacklisted from access to NBP and/or other location services.

Should the alternate AP 105-2 also be a trusted AP (e.g. part of a WLAN for the venue associated with the target location 120) in the above example, WDIV (e.g. implemented in the location server 160) may request one or more trusted APs to report all wireless devices that are visible to each AP or just report whether a particular wireless device with the ID provided by the alternate (spoofing) device 110-2 is visible to each AP. Assuming that the alternate device 110-2 is falsely claiming the ID of the target device 110-1, the trusted AP 105-1 will report receiving this ID (since target device 105-1 is within coverage of AP 105-1), but alternate AP 105-2 will not report receiving this ID (because target device 110-1 is not within coverage of alternate AP 105-2). WDIV may then determine that alternate device 110-2 may be falsely claiming the ID of another wireless device (here target device 110-1) because the AP reported as seen by the alternate device 110-2 (AP 105-2) does not match the trusted AP (AP 105-1) that receives signals from a wireless device with the ID claimed by alternate device 110-2. In response to determining a possibility of spoofing, the alternate device 110-2 may be blocked or otherwise blacklisted from access to NBP and/or other location services.

Three alternative scenarios may be distinguished in FIG. 1 to illustrate WDIV. In the first scenario related to FIG. 1, target device 110-1 requests location services from location server 160 or from LBS application server 155 and provides its correct MAC address. Target device 110-1 may communicate with location server 160 and/or with LBS application server (LBS AS) 155 via local AP 105-1 and/or via other means (e.g. via other APs, base stations and/or network 150). If target device 110-1 requests location services from LBS application server 155 and provides its MAC address (or references a MAC address previously provided by target device 110-1 to LBS AS 155), LBS application server 155 may transfer the request and the provided MAC address of target device 110-1 to location server 160. Location server 160 may then employ NBP to locate target device 110-1 and may return the location (e.g. periodically) to LBS AS 155 which may then return the location to target device 110-1. In one embodiment, to support NBP, location server 160 may provide the MAC address originally provided by target device 110-1 to APs such as AP 105-1 that may be nearby to target device 110-1 and able to receive and measure signals transmitted by target device 110-1. The signals may be identified as being transmitted by target device 110-1 because they include the MAC address previously provided by target device 110-1 to LBS AS 155. However, before employing NBP to locate target device 110-1, location server 160 may verify the MAC address provided by target device 110-1 since the integrity of the MAC address may be critical to correct operation of NBP. Location server 160 may request target device 110-1 to return the MAC addresses of APs visible to target device 110-1 and possibly measurements of signals received from these APs such as RSSI, RTT and/or AOA. Location server 160 may also or instead request target device 110-1 to provide an estimate of its current location using MBP or may obtain an estimate of this location itself using wireless device assisted MBP wherein measurements of APs are obtained and returned by target device 110-1 to location server 160 as described earlier herein. Location server 160 may also request APs that may be nearby to target device 110-1 (such as AP 105-1) to indicate whether they can detect signals or messages transmitted from target device 110-1 based on inclusion of the MAC address of target device 110-1 in such signals or messages. APs that can detect such signals may indicate detection of the signals to location server 160 and may further provide their own (AP) MAC addresses. In some embodiments, an AP (e.g. AP 105-1) makes and returns measurements (e.g. of RTT, RSSI and/or AOA) using the detected signals or messages. Location server 160 may further or instead obtain an estimate for the location of target device 110-1 using NBP based on measurements of signals transmitted by target device 110-1 obtained and returned by nearby APs such as AP 105-1, as described earlier herein

Location server 160 now has two sets of information that can be compared. The first set comprises information provided by target device 110-1 related to APs nearby to target device 110-1. The second set comprises information received from APs that can detect signals or messages from target device 110-1. Since in this first scenario, target device 110-1 has provided a correct MAC address, the two sets of information will closely match one another. For example, target device 110-1 may indicate that it detected the MAC address of AP 105-1 while AP 105-1 may report that it detected the MAC address of target device 110-1. Similarly, target device may measure and report an RSSI, RTT and/or AOA for AP 105-1 that is the same as or is consistent with (e.g. correlates with) an RSSI, RTT and/or AOA measured and reported by AP 105-1 based on signals or messages received from target device 110-1. For example, RSSI or RTT measurements may be considered to be consistent if they indicate a similar distance (or range) between AP 105-1 and target device 110-1, whereas AOA measurements may be considered to be consistent if they indicate directions that are approximately in opposition (e.g. with AP 105-1 measuring an AOA in Northerly direction and target device 110-1 measuring an AOA in a southerly direction). Finally, any location provided by target device 110-1 or obtained by location server 160 using wireless device assisted MBP from measurements provided by target device 110-1 may be the same as or almost the same as (e.g., within a threshold distance of) a location obtained by location server 160 using NBP from measurements provided by AP 105-1 and possibly by other trusted APs able to receive signals or messages from target device 110-1. Because the two sets of information match and were obtained by separate wireless devices, one set of which (i.e. the APs) can be trusted, it means target device 110-1 can credibly be assumed to be using the MAC address it provided to location server 160 or LBS application server 155.

In the second scenario illustrating WDIV related to FIG. 1, the alternate device 110-2 requests location services from location server 160 or from LBS application server 155 but provides an incorrect MAC address (e.g., a MAC address for target device 110-1). In this scenario, location server 160 may again request the alternate device 110-2 to provide the MAC addresses of nearby APs visible to alternate device 110-2 and may request RSSI, RTT and/or AOA measurements for these APs and may further request alternate device 110-2 to provide a location estimate or measurements that location server 160 can use to obtain the location of alternate device 110-2 using wireless device assisted MBP. Alternate device 110-2 may then provide the information applicable to its location which in this example could include providing the identity of AP 105-2 and possibly RSSI, RTT and/or AOA measurements related to AP 105-2 as well as a location or measurements related to a location of alternate device 110-2 somewhere in the area of location 140. Alternatively, alternate device 110-2 might provide incorrect information on nearby APs in an attempt to appear to be at the location of target device 110-1. However, unless alternate device 110-2 already knows the location of target device 110-1 (in which case there is less benefit in obtaining location information for target device 110-1 from location server 160 or from LBS application server 155), this incorrect information may not match the information applicable to target device 110-1.

As in the first scenario, location server 160 may request APs such as AP 105-1 and possibly AP 105-2 to indicate if a wireless device is detected transmitting the MAC address claimed by alternate device 110-2. Since this was an incorrect MAC address in this scenario, AP 105-2 may not detect the MAC address. However, if the incorrect MAC address corresponds to the MAC address of target device 110-1, then AP 105-1 may report that it can detect the MAC address (if target device 110-1 is currently transmitting) and may provide associated RSSI, RTT and/or AOA measurements. Since alternate device 110-2 would most likely not have reported the identity of AP 105-1 or provided RSSI, RTT and/or AOA measurements for AP 105-1 corresponding to or consistent with any measurements made by AP 105-1 for the spoofed wireless device 110-1, there will be a mismatch between the information provided by alternate device 110-2 and the information provided by APs such as AP 105-1. In addition, any location reported by or derived from measurements from alternate device 110-2 will likely not match any location for the spoofed wireless device 110-1 derived using NBP from measurements obtained from APs such as AP 105-1. Based on this mismatch, location server 160 can conclude that alternate device 110-2 did not provide a correct MAC address and can deny provision of service such as providing NBP based location to alternate device 110-2.

In the third scenario illustrating WDIV related to FIG. 1, an authorized external client (e.g. LBS AS 155 in FIG. 1) requests the location of target device 110-1 and provides the correct MAC address for target device 110-1 and may further provide another correct ID for target device 110-1 such as an IMSI or a user ID known to the venue. In this scenario, alternate device 110-2 is assumed to be spoofing the MAC address of target device 110-1 (either accidentally or by design) by including this MAC address in signals transmitted by alternate device 110-2 in order possibly to provide a false location for target device 110-1 to an external client such as LBS AS 155. In this scenario, since the external client has provided a correct ID or IDs for target device 110-1, location server 160 may correctly identify the target device 110-1 and may request the target device 110-1 to provide the MAC addresses of nearby APs visible to target device 110-1, may request RSSI, RTT and/or AOA measurements for these APs and may further request target device 110-1 to provide a location estimate or measurements that location server 160 can use to obtain the location of target device 110-1 using wireless device assisted MBP. If target device 110-1 is within the venue, target device 110-1 may then provide the information applicable to its location which in this example could include providing the identity of AP 105-1 and possibly RSSI, RTT and/or AOA measurements related to AP 105-1 as well as a location or measurements related to a location of target device 110-1 somewhere in the area of target location 120. Alternatively, if target device 110-1 is not within the venue, target device 110-1 may indicate that it is unable to detect any APs or may provide IDs for visible APs outside the venue or may not respond (e.g. if target device is powered down, out of wireless coverage or otherwise unreachable from the location server 160).

As in the first and second scenarios, location server 160 may request APs such as AP 105-1 and AP 105-2 to indicate if a wireless device is detected transmitting the MAC address provided by the external client and being used (in this scenario) by both target device 110-1 and (falsely) by alternate device 110-2. In this scenario, AP 105-2 may report detecting the MAC address due to receiving signals transmitted by the spoofing device 110-2. AP 105-1 may also report detecting the MAC address due to receiving signals transmitted by target device 110-1 if target device 110-1 is inside the venue. Location server 160 can then observe that the MAC address of AP 105-2 that reported seeing the MAC address of target device 110-1 was not observed by target device 110-1 and that AP 105-2 may be distant from any AP (such as AP 105-1) that target device 110-1 reported as being visible. Location server 160 may also observe that, when target device 110-1 is within the venue, two widely separated APs (namely APs 105-1 and 105-2 in this scenario) report seeing the MAC address of target device 110-1. The mismatch between any measurements provided by target device 110-1 and measurements provided by APs (or the lack of any measurements provided by the target device 110-1 versus the provision of measurements by an AP or APs in the venue) and/or the possible inconsistency of information provided by different APs (here APs 105-1 and 105-2) can indicate to location server 160 that the address provided by the external client for target device 110-1 is either invalid or is valid but is being spoofed (e.g. transmitted) by a device different to target device 110-1. In response to this determination, the location server 160 may withhold providing a location for target device 110-1 obtained using NBP to the external client. Instead, the location server 160 may use MBP to locate target device 110-1 and provide this location to the external client if the location server is able to use MBP to locate the target device 110-1 without relying on the MAC address for target device 110-1.

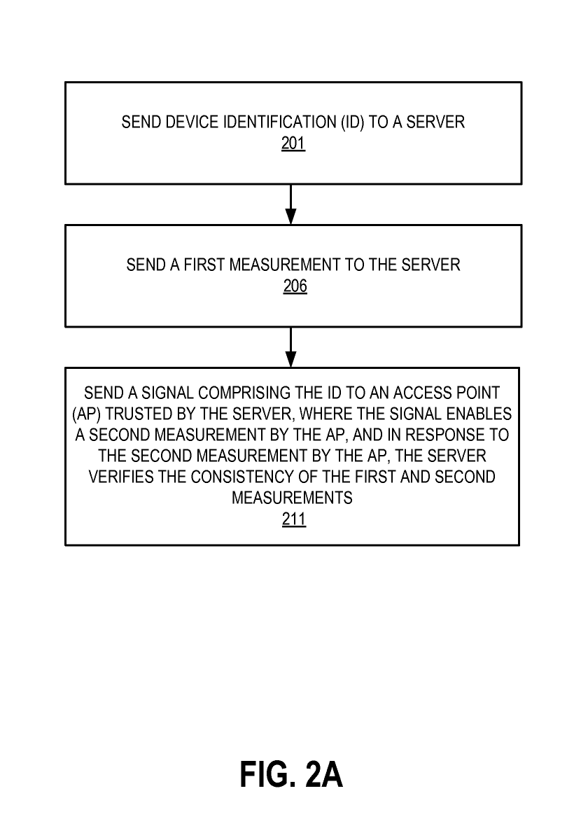

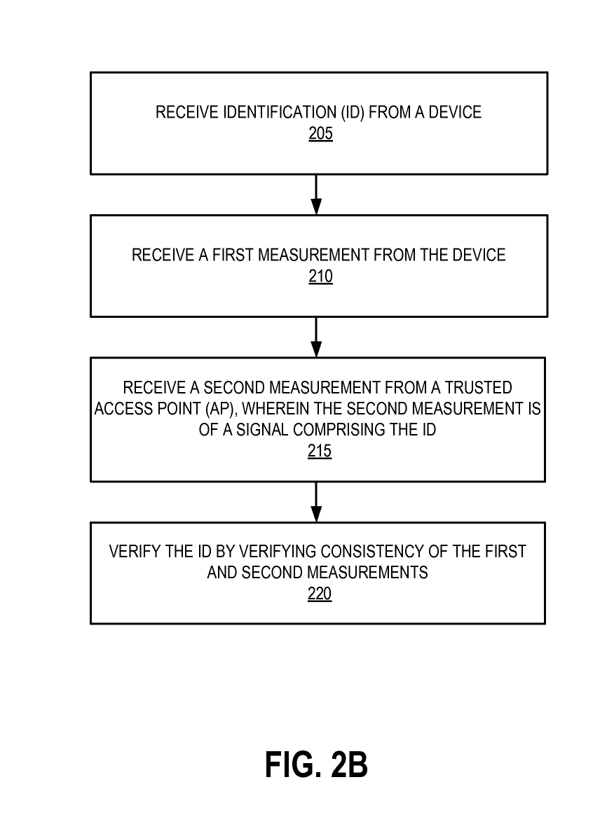

FIG. 2A is a flow diagram illustrating one embodiment of a method for performing WDIV at a wireless device—e.g. the wireless device 110-1 or 110-2 in FIG. 1. At block 201, the wireless device sends an identification (ID) for the wireless device to a server (e.g. the location server 160 in FIG. 1). For example, the ID may be an Electrical and Electronics Engineers (IEEE) 802.xx media access control (MAC) address.

At block 206, the wireless device sends a first measurement to the server. In one embodiment, the first measurement includes a first MAC address of an AP visible to the wireless device. In some embodiments, the first measurement also includes one or more of a first RSSI, a first AOA or a first RTT obtained from signals transmitted by and received from the AP having the first MAC address. In some embodiments, the first measurement may include a MBP location result (e.g. a location estimate for the wireless device obtained by the wireless device using MBP). In some embodiments, the first measurement is used by the server to determine a first location of the wireless device.

At block 211, the wireless device sends a signal comprising the ID to an AP trusted by the server. In some embodiments, the signal may be broadcast by the wireless device to all APs nearby to the wireless device. In other embodiments, the signal may be transmitted specifically to the trusted AP (e.g. if there is a signaling association between the wireless device and the trusted AP). The signal may enable a second measurement by the trusted AP, and in response to the second measurement by the trusted AP, the server may verify the consistency of the first and second measurements. In one embodiment, the second measurement includes the ID of the wireless device and the ID of the trusted AP. In some embodiments, the second measurement includes one or more of a second RSSI, a second AOA or a second RTT obtained from the signal transmitted by the wireless device. In some embodiments, the second measurement is used by the server to determine a second location of the wireless device. In some embodiments, verifying the consistency of the first and second measurements may include verifying that (i) the first measurement contains the ID of the trusted AP and the second measurement contains the ID of the wireless device, (ii) the first RSSI and/or the first RTT in the first measurement implies the same distance between the wireless device and the trusted AP within a threshold level of confidence as the second RSSI and/or the second RTT in the second measurement, (iii) the first AOA in the first measurement and the second AOA in the second measurement refer to opposite directions within a threshold level of confidence, and/or (iv) the first and second locations determined by the server are within a threshold distance of one another. In an embodiment, the wireless device ID may be considered as verified (e.g. by the location server) if consistency of the first and second measurements is verified at block 211.

FIG. 2B is a flow diagram illustrating one embodiment of a method of WDIV performed at a server—for example at the location server 160 in FIG. 1 or the LBS AS 155 in FIG. 1. At block 205, the server receives an ID (device ID) claimed by a device (e.g. the wireless device 110-1 or alternate device 110-2 in FIG. 1). For example, the ID may be an Electrical and Electronics Engineers (IEEE) 802.xx media access control (MAC) address.

At block 210, the server receives a first measurement from the device. In one embodiment, the first measurement includes a first MAC address for a trusted AP detected (or claimed to be detected) by the device. In some embodiments, the first measurement also includes one or more of a first RSSI, a first AOA or first RTT associated with the AP having the first MAC address. In some embodiments, the first measurement may be a mobile-based positioning location result. In some embodiments, the first measurement includes or is used to determine, a first location of the device.

At block 215, the server receives a second measurement from a trusted access point (AP), where the second measurement is of a signal comprising the ID. For example, the second measurement may be a second MAC address comprising a MAC address for the trusted AP and may also include at least one of a second RSSI, a second AOA and second RTT determined from at least one signal comprising the ID. In some embodiments, the second measurement may be a network based positioning location result. In some embodiments, the second measurement includes or is used to determine, a second location of the device.

At block 220, the server verifies the ID by verifying consistency of the first and second measurements. Verifying consistency may include determining that the first and second MAC addresses are the same MAC address and/or determining that the first RSSI, first AOA or first RTT corresponds with the second RSSI, second AOA or second RTT within a correspondence threshold. In one embodiment, the correspondence threshold comprises one or more of equality, similarity, opposition or correlation of the first and second RSSI or RTT values. Correlation and similarity may be user defined or may use predetermined values or ranges. In some embodiments, verifying consistency includes determining the first and second locations are within at least a threshold (e.g., user defined or predetermined value) distance to each other.

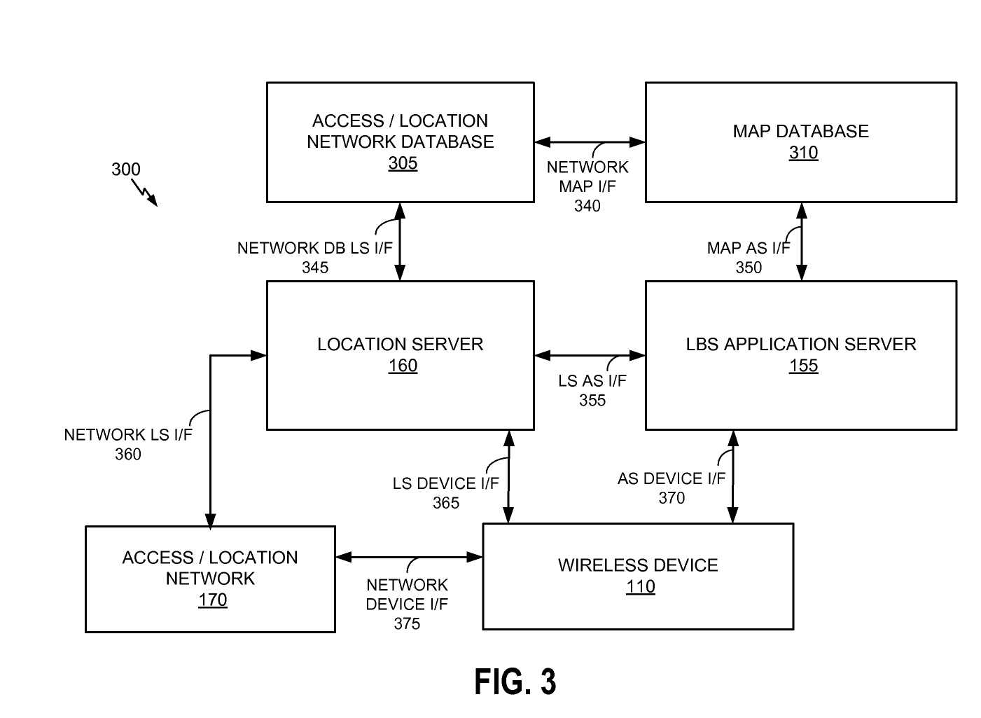

FIG. 3 is an exemplary illustration of a system 300 for performing WDIV. In an embodiment, the system 300 may correspond in whole or in part to an architecture defined by an organization known as the In-Location Alliance (ILA) for supporting location of wireless devices in indoor environments. In one embodiment, WDIV system 300 includes an Access/Location Network Database (ALN DB) 305, a Map Database (Map DB) 310, a Location Server (LS) 160, a Location Based Services Application Server (LBS AS) 155 (which may in some embodiments be a more generic Application Server (AS) supporting both LBS and other services), an Access/Location Network (ALN) 170, and one or more types of user equipment (e.g., wireless device 110). In some embodiments, WDIV system 300 may include additional elements (e.g. a privacy policy database not shown in FIG. 3), whereas in some other embodiments, WDIV system 300 may include some but not all elements shown in FIG. 3 (e.g. where Map DB 310 and/or ALN DB 305 may be omitted).

Wireless device 110 in system 300 may correspond to target device 110-1 or to alternate device 110-2 in operating environment 100 in FIG. 1. ALN 170 may include AP 105-1 and possibly AP 105-2 in operating environment 100 in FIG. 1 and may further include or comprise network 150 in operating environment 100 in FIG. 1. ALN 170 may comprise entities whose primary or only role is to support locating wireless devices such as wireless device 110 (e.g. by transmitting positioning related radio signals to be measured by wireless device 110 and/or by receiving and measuring radio signals transmitted by wireless device 110) as well as entities whose primary or only role is to facilitate communication between wireless devices, such as wireless device 110, and other entities including but not limited to entities in FIG. 3 such as LS 160 and LBS AS 155.

LS 160 in FIG. 3 may correspond to LS 160 in FIG. 1 and may (e.g., if requested) determine location related information (e.g., a location estimate or presence in a particular area) for wireless devices (e.g. wireless device 110) and may provide this location information to other entities such as the wireless device to which the location information applies (e.g., wireless device 110) or other entities (e.g., LBS AS 155). LS 160 may also provide location assistance data to wireless devices (e.g. wireless device 110) to assist wireless devices to make location related measurements and calculate their own estimated locations from these measurements. LS 160 may interact with a wireless device to determine the location of the wireless device using MBP or provide location assistance data to a wireless device to enable the wireless device to obtain its own location using MBP. LS 160 may also or instead interact with ALN 170 to obtain location related information for one or more wireless devices (e.g., location measurements for wireless device 110 made by or obtained by devices in ALN 170) that may enable LS 160 to obtain a location for each of the one or more wireless devices using NBP. In some embodiments, LS 160 may be a Home SUPL Location Platform (H-SLP) or a Discovered SUPL Location Platform (D-SLP) supporting the SUPL location solution defined by the Open Mobile Alliance (OMA), or may be an Enhanced Serving Mobile Location Center (E-SMLC) supporting the control plane location solution for LTE access defined by 3GPP.

LBS AS 155 in FIG. 3 may correspond to LBS AS 155 in FIG. 1 and may support one or more LBS services on behalf of wireless devices (e.g., wireless device 110), external clients and/or owners, operators or managers of a network or venue. Such services may include provision of directions, navigation support, map data and/or other location related information to the users of wireless devices and provision of information about wireless devices (e.g., number of wireless devices in a certain area, dwell time of wireless devices in an area, location histories of wireless devices) to external clients and/or to venue or network owners or operators. To support LBS services, LBS AS 155 may request and obtain location information for particular wireless devices or any wireless device (e.g. wireless device 110) from LS 160. ALN DB 305 may store information related to devices (e.g. APs or femtocells) in ALN 170 such as almanac data that may include the location of each device (e.g., latitude, longitude and possibly altitude), its wireless characteristics (e.g. wireless technologies supported), antenna characteristics and transmission characteristics (e.g., transmission power, transmission timing) ALN DB 305 may provide information (e.g., concerning ALN 170) to a location server (e.g., LS 160) when requested and/or when certain conditions arise (e.g. availability of new information) to assist the location server to provide location assistance data to wireless devices and/or to determine location or presence information for wireless devices (e.g., determine a location for wireless device 110 using NBP from measurements related to wireless device 110 provided by ALN 170, and/or using MBP from measurements provided by wireless device 110). Map DB 310 may store maps and map related information (e.g., layout of stores in a shopping mall) for a certain area (e.g., a venue, town, city, building) and may provide some of this information (e.g., if requested) to LBS AS 155 and/or to ALN DB 305. LBS AS 155 may use the information received from Map DB 310 to provide LBS services to wireless devices (e.g., wireless device 110). ALN DB 305 may use the information received from Map DB 310 to enhance the information that ALN DB 305 is able to provide to a location server (e.g., LS 160) and/or to enable ALN DB 305 to infer or calculate information related to ALN 170 such as calculating a radio map that includes the signal strength expected to be received from an AP 105-1 or 105-2 in ALN 170 at different locations in the coverage area of the AP in a building or venue.

The entities shown in FIG. 3 for the WDIV system 300 may interact pairwise with one another over the interfaces (I/Fs) represented by double arrows in FIG. 3. For example: (i) wireless device 110 may send messages to LS 160 over the LS device interface 365 (which may typically be a wireless interface) that may include a device ID claimed by wireless device 110 and/or location related measurement information for wireless device 110; (ii) wireless device 110 may send a signal to APs in ALN 170 over network device interface 375 (which may typically be a wireless interface) that may include a device ID for wireless device 110 and that may allow one or more APs in ALN 170 (e.g. AP 105-1) to receive the device ID and measure some characteristic of the signal such as RSSI, AOA or RTT; and (iii) ALN 170 (e.g. AP 105-1 in ALN 170) may send a message to LS 160 over network LS interface 360 (which may typically be a wireline interface or a dedicated wireless backhaul interface) that may include the identity of a trusted AP in ALN 170 (e.g. AP 105-1) that has made a measurement of a signal containing an ID claimed by wireless device 110 and may further include the measurement information (e.g. a measurement of RSSI, AOA or RTT). In another example, wireless device 110 may send messages to LBS AS 155 over the AS device interface 370 (which may typically be a wireless interface) that may include a device ID claimed by wireless device 110 and LBS AS may forward the device ID to LS 160 over LS AS interface 355 (which may typically be a wireline interface). LS 160 may compare the measurement information received from ALN 170 over I/F 360 with the measurement information received from wireless device 110 over I/F 365 to verify the device ID claimed by wireless device 110 as described elsewhere herein.

In one embodiment, WDIV system 300 independently verifies that a MAC address provided by a particular wireless device (in this example, wireless device 110), or provided by some other entity (e.g. by LBS AS 155) for authorized location of wireless device 110, actually belongs to wireless device 110. A method enabling this may use the elements in the WDIV system 300 and makes use of both NBP and MBP.

When the wireless device 110 first enters a venue or other defined location (e.g. a building or floor of a building) or when the LS 160 needs to verify that an ID (e.g. a MAC address) claimed by the wireless device 110 is correct, the LS 160 can invoke both NBP and MBP or make use of information previously obtained by LS 160 for the wireless device 110 using MBP and/or NBP. For MBP, LS 160 can request the wireless device 110 to report measurements for visible APs (e.g., their MAC addresses and/or additional measurements such as measurements of RSSI, AOA and/or RTT for signals received from the visible APs). For NBP, LS 160 can request measurement information from one or more APs in ALN 170 of signals (e.g. IEEE 802.11x signals) transmitted by wireless device 110 and carrying or being associated with the ID claimed by wireless device 110. The measurement information provided by ALN 170 may include the IDs (e.g. MAC address) of some or all APs that are able to detect signals carrying or being associated with the ID claimed by the wireless device 110. Signals associated with the ID claimed by wireless device 110 may be signals that do not explicitly contain the ID claimed by wireless device 110 but are part of a common signaling procedure (e.g. a procedure defined for an IEEE 802.11x protocol or for 3GPP LTE) that includes other signals or messages transmitted by the wireless device 110 that do contain the ID claimed by the wireless device 110. The measurement information provided by ALN 170 may further include measurements of some characteristic of the signals carrying or associated with the ID claimed by the wireless device 110 such as RSSI, AOA or RTT. LS 160 can verify that the set of APs reported as being visible by the wireless device 110 match the set of APs reported by ALN 170 as being able to detect signals carrying or being associated with the ID claimed by the wireless device 110. There may not be an exact match between the two sets of APs; however, there should be at least one or more APs in common in the two sets, or the two sets of APs should at least comprise APs in the same local area. The level of required match of the two sets of APs may be a configurable parameter in LS 160 that may define a threshold level for determining a match. For example, when security is considered high priority, the threshold may require that most APs in the two sets be the same. Conversely, when security is considered lower priority (e.g. in a venue where LS 160 and LBS AS 155 provide wireless device location information to a venue operator or owner but not to external clients or wireless devices), the threshold may allow for only one AP in common in the two sets or no APs in common but with the two sets of APs being required to be in the same local area. LS 160 may also calculate locations for wireless device 110 from the received MBP and NBP measurements and may verify they approximately match as a condition for verifying the correctness of the ID claimed by the wireless device 110. In obtaining a location using MBP, the MBP location measurements received from wireless device 110 could be for Wi-Fi based position methods (e.g. could include RSSI, AOA and RTT measured by wireless device 110 for one or more APs in ALN 170) and/or could be for other MBP position methods such as A-GNSS and/or OTDOA. The MBP location may be further obtained using wireless device assisted MBP (in which wireless device 110 sends measurements to location server 160 rather than sending a location computed by wireless device 110) to enable a more reliable location to be computed by location server 160 in which spoofing by wireless device 110 would be more difficult and thus less likely.

In some embodiments, in response to verifying the ID claimed by wireless device 110, LS 160 may use NBP for a specified period of time to locate and track the wireless device 110 (based on measurement of signals containing the verified ID by APs in ALN 170) before again re-verifying the claimed ID of wireless device 110 (e.g. which might be configured to occur only periodically such as every hour). While correct use NBP can depend on having a verified ID (e.g. MAC address) for wireless device 110 due to the possibility of spoofing as already described, WDIV system 300 (e.g. LS 160 in WDIV system 300) may determine that NBP is more efficient than MBP if many wireless devices are being located simultaneously (e.g. at a busy airport or shopping mall) and may thus have a preference for using NBP rather than MBP. LS 160 may then prioritize NBP over MBP in some instances, and therefore verification of IDs claimed by the different wireless devices may be beneficial.

As just described, in order to assist with verification of an ID claimed by wireless device 110, LS 160 may compare measurements made by wireless device 110 of one or more trusted APs in ALN 170 and reported to LS 170 with measurements made by the same trusted APs in ALN 170 of received signals carrying or being associated with the ID claimed by wireless device 110 and reported by ALN 170 to LS 160. The measurements may include measurements of RSSI, AOA and/or RTT as previously described and LS 160 may verify that measurements of RSSI, AOA and/or RTT made by wireless device 110 of some AP (e.g. AP 105-1) are consistent with (e.g. approximately equal to) the same types of measurements made by the AP of signals received by the AP carrying or being associated with the ID claimed by the wireless device 110. In one embodiment, to verify consistency, a threshold is configured such that (i) RTTs should be approximately the same, (ii) AOAs should be approximately opposite (e.g. if a wireless device measured AOA is 5 degrees clockwise from North, the AP measured AOA should be approximately 185 degrees clockwise from North) and (iii) normalized RSSI measurements should be correlated. As an example of RSSI correlation, if a wireless device's RSSI measurement for a first AP is higher than for a second AP when both RSSI measurements are normalized with respect to AP transmission power, then the first AP's RSSI measurement for signals carrying or being associated with the wireless device ID should exceed the second AP's RSSI measurement for these signals. In addition, the ratio of the wireless device's normalized RSSI measurements for the first and second APs and the ratio of the first and second APs' RSSI measurements for signals carrying or being associated with the wireless device ID should be approximately the same (though as signals may travel using different paths in uplink and downlink directions, the ratios may be somewhat different).

In one embodiment, wireless device 110 sends and receives communication to ALN 170, LS 160, and LBS AS 155 that cannot be initially associated with a verified ID for wireless device 110 since wireless device 110 is not part of WDIV system 300 and communication over wireless interfaces 365, 370 and 375 may be spoofed as previously described. In contrast to wireless device 110 communication, Access/Location Network Database to Map Database I/F 340, Access/Location Network Database to location server I/F 345, Access/Location Network to location server I/F 360, Map Database to application server I/F 350, and location server to application server I/F 355 are deemed trustworthy communication within the control of the WDIV system 300.

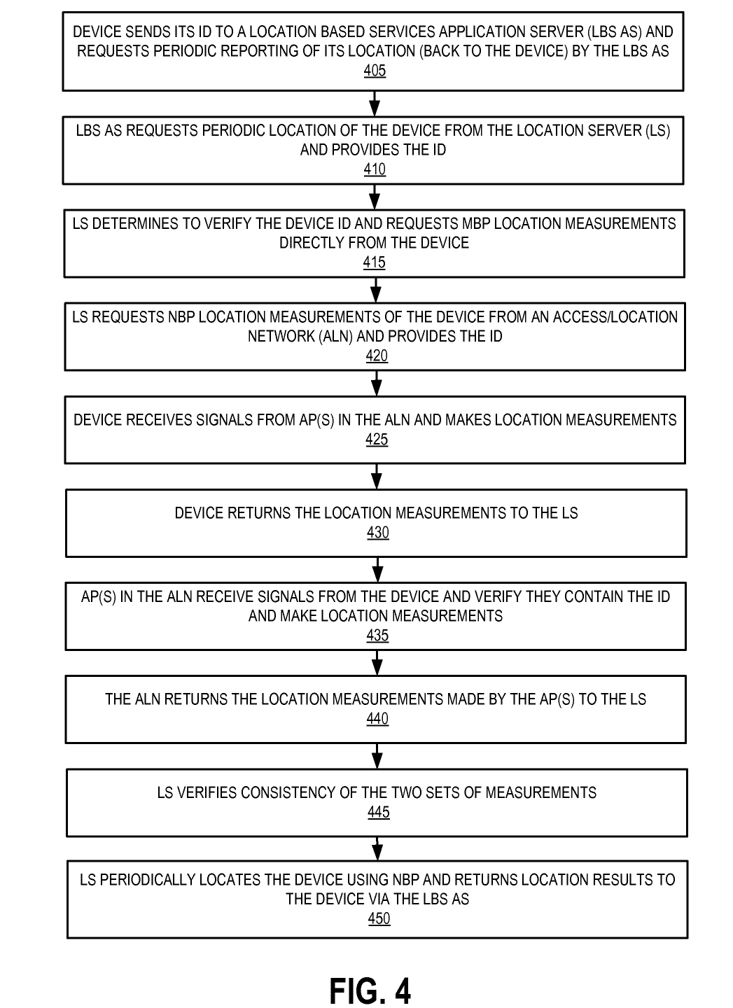

In one embodiment, communication sent from the wireless device 110 may be classified as unverified or potentially untrustworthy until WDIV system 300 has verified the wireless device 110 identification. For example, when the wireless device 110 enters a venue for WDIV system 300, the wireless device 110 may broadcast or send a MAC address identification on an I/F (e.g., one of the WDIV system 300 wireless I/Fs 365, 370 or 375). In one embodiment, WDIV system 300 can verify the broadcast or sent MAC address as described earlier herein and as described next using FIG. 4.

FIG. 4 is a flow diagram illustrating a method for performing WDIV, in another embodiment. In some embodiments, the method may be performed or executed by one or more components within operating environment 100 of FIG. 1. For example, the method may be performed by one or more of: location server 160, LBS application server 155, AP 105-1 and/or AP 105-2, and wireless device 110-1 or 110-2. In some embodiments, the method may also or instead be performed or executed by one or more components within WDIV system 300 of FIG. 3. For example, the method may be performed by one or more of: location server 160, LBS application server 155, ALN 170 and wireless device 110. It should be appreciated that since WDIV system 300 and operating environment 100 may show different elements of a common system, that the method in FIG. 4 may be performed or executed by elements of both systems.

At block 405, a target wireless device (e.g., target device 110-1 or alternate device 110-2 in operating environment 100 or wireless device 110 in WDIV system 300) sends its device ID (e.g., MAC address of the wireless device) to an LBS application server (e.g., LBS application server 155) and requests that the LBS application server provide reporting (e.g., periodic reporting) of the target wireless device's location back to the target wireless device. The target wireless device may also provide a second ID to the LBS application server such as a user ID of logon ID that the LBS application server may be able to authenticate (e.g. via a logon/password procedure), However, authenticating the second ID may not verify the device ID, since a wireless device (or the user of a wireless device) with a valid user ID or valid logon ID may still spoof a device ID belonging to some other wireless device.

At block 410, the LBS application server requests periodic location of the target wireless device from a location server (e.g., location server 160). In one embodiment, the LBS application server also provides the target wireless device ID to the location server. In some embodiments, the LBS application server may also provide the second ID to the location server or a third ID (e.g. a venue assigned ID) that is associated one to one with the second ID.

At block 415, the location server may determine that the device ID should be verified—e.g. because the location server needs to use NBP to periodically locate the target wireless device at block 450 (as described further on) based on the device ID and needs to be sure that the device ID is valid (e.g. and not incorrect or spoofed). The location server may identify the target wireless device using the second ID or third ID rather than by using the device ID which may not be considered as verified yet. The location server then requests MBP location measurements from the target wireless device for one or more APs that are visible to the target wireless device. For example, the location server may send a request message directly to the target wireless device and may establish a location session with the wireless device—e.g. a SUPL session as defined for the OMA SUPL location solution. In one embodiment, the request message may pass transparently through a wireless network (e.g., network 150 and/or ALN 170) and/or an AP. In some embodiments, the request message may be a message, or may contain an embedded message, defined for the SUPL location solution defined by OMA, the LTE positioning protocol (LPP) defined by 3GPP or the LPP Extensions (LPPe) protocol defined by OMA. In some embodiments, the target wireless device may provide a fourth ID to the location server (e.g. when the location server establishes a SUPL session with the target wireless device) which may be an International Mobile Subscriber Identity (IMSI), a Mobile Station International Subscriber Directory Number (MSISDN) or an International Mobile Equipment Identity (IMEI) in some embodiments. The location server may authenticate the fourth ID—e.g. using the Transport Layer Security (TLS) mechanism defined by IETF. In some embodiments the fourth ID may be the same as the second ID or third ID and may enable the location server to verify that the target wireless device to which the request message was sent is the same target wireless device that sent the device ID to the LBS application server at block 405. In some embodiments, the target wireless device may send the claimed device ID to the location server as part of block 415 in which case the claimed device ID may not be sent by the target wireless device to the LBS application server at block 405 and/or may not be sent by the LBS application server to the location server at block 410. However, whether the location server obtains the claimed device ID from the target wireless device or from the LBS application server, the location server may not consider the claimed device ID as being verified even if the LS authenticates the fourth ID for the target wireless device, since a target wireless device (or the user of a target wireless device) with a valid second, third and/or fourth ID may still spoof the claimed device ID. Thus verifying the claimed device ID may be needed.

At block 420, the location server requests NBP location measurements of the wireless device from an ALN (e.g. ALN 170). In one embodiment, the location server also provides the device ID to the ALN. In one embodiment, the location server sends an NBP request including the device ID to an intermediate entity in the ALN (e.g. a router or ALN controller) which forwards the request to one or more APs in the ALN (e.g. to AP 105-1 or AP 105-2). In another embodiment, the location server sends an NBP request including the device ID directly to each of one or more APs in the ALN.

At block 425, the target wireless device receives signals from one or more APs in the ALN that contain or are associated with an ID (e.g. a MAC address) of the AP that is sending each signal. The target wireless device then makes location measurements using these signals based on the MBP request received at block 415. For example, the target wireless device can obtain the MAC address for each AP from which a signal is measured and may make measurements of RSSI, AOA and/or RTT.

At block 430, the target wireless device returns the MBP location measurements, including the IDs of the APs for which they were each made, to the location server.

At block 435, an AP in the ALN receives signals (e.g., IEEE 802.11 frames) from the target wireless device and verifies the signals contain or are associated with the device ID and makes location measurements. For example, the AP may obtain the device ID and may measure the RSSI, AOA or RTT using the signals. Block 435 may be performed by more than one AP in the ALN—e.g. may be performed by each AP that receives an NBP request sent or forwarded at block 420.

At block 440, the ALN returns the location measurements made by the AP(s) at block 435 to the location server together with the device ID and the ID(s) of the AP(s) (e.g. AP MAC address(es)). In some embodiments, the location measurements may be returned by the AP(s) in the ALN to an intermediate entity (e.g. an ALN controller or router) which may forward the location measurements in individual messages for each AP or combined into a single message (or single message set) for all APs to the location server. In other embodiments, each AP may individually and directly return the location measurements made by that AP to the location server. In some embodiments, the device ID may not be returned to the location server along with the location measurements—e.g. if the device ID is implicitly known by the location server due to an association (e.g. inclusion in a common procedure) of each location measurement response sent at block 440 to an NBP request sent at block 420.

At block 445, the location server verifies consistency of the two sets of location measurements received at blocks 430 and 440. For example, the location server may verify consistency or non-consistency (whichever applies) as described herein in association with FIGS. 1, 2B and 3. In addition, the location server may verify that each set of location measurements is self-consistent. For example, the location server may verify that two or more APs that are widely separated from one another (e.g. by one kilometer or more) are not included in the measurements received at block 440 that would otherwise indicate detection of the (same) device ID by widely separated APs (e.g. which may occur when spoofing according to the third scenario described in association with FIG. 1 occurs). If the two sets of location measurements are found to be consistent (and self-consistent), the location server may determine that the device ID received at block 410 (or at block 415) is valid and may periodically locate the target wireless device using NBP at block 450. Periodic location at block 450 may include performing blocks 420, 435 and 440 for each periodic location in some embodiments or, in other embodiments, performing block 420 once for all periodic locations with the ALN then performing blocks 435 and 440 periodically for each periodic location. For each periodic location obtained using NBP at block 450, the location server may return the location to the LBS application server which may in turn return the location to the target wireless device. In some embodiments, the location server may obtain at least some of the periodic locations at block 450 using MBP instead of or in addition to NBP.

In some embodiments of the method in FIG. 4, the location server does not include the device ID in the NBP request(s) sent to the ALN at block 420 and instead requests measurement information from the ALN or directly from APs in the ALN for all wireless devices that are visible to each AP. In this embodiment, the ALN may return location measurements for a plurality of wireless devices at block 440 and may include the device ID received from each wireless device in the plurality. The plurality of wireless devices may include the target wireless device thereby allowing the location server to perform block 445 to verify the device ID for the target wireless device.

It should be appreciated that while the method in FIG. 4 assumes one ALN, the location server may request and/or receive NBP and MBP measurements related to more than one ALN (e.g. by repeating blocks 420, 435, 440 for each ALN in the case of NBP and by including or referencing APs for more than one ALN in blocks 415, 425 and 430 in the case of MBP).

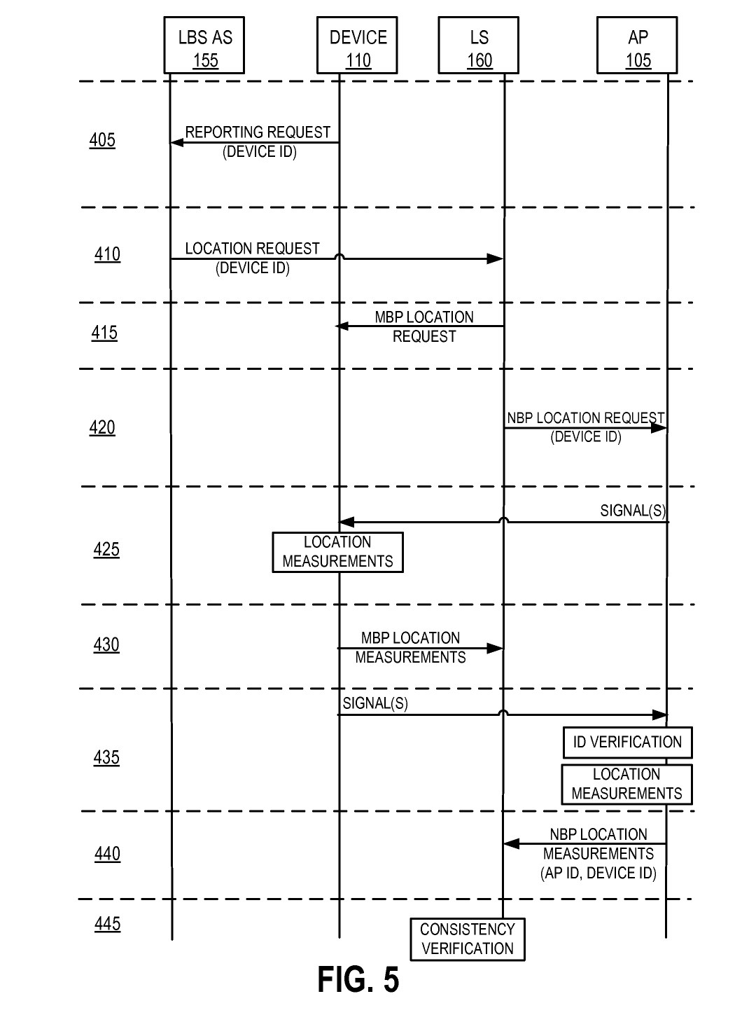

FIG. 5 illustrates the flow of messages of FIG. 4 for blocks 405 to 445, in one embodiment in which a location server 160 requests NBP measurements directly from a single AP in the ALN. For example, FIG. 5 shows messages that are sent or received by an LBS application server 155, wireless device 110 (e.g., wireless device 110-1 or wireless device 110-2), location server 160, and AP 105 (e.g., AP 105-1 or AP 105-2) in the ALN. FIG. 5 also shows the correspondence between each message and/or activity within a single entity and each block of FIG. 4.

In some embodiments, messages may be transferred in a different order or arrangement than described above with relation to FIG. 5 and FIG. 4. For example, the MBP and NBP location requests may be sent at the same time or the NBP location request may be sent before the MBP location request. In addition, some messages may be repeated in FIG. 5. For example, the reception of signals and performing location measurements by the wireless device 110 in FIG. 5 corresponding to block 425 may be repeated when the wireless device obtains MBP location measurements for more than one AP 105. Similarly, the transmission of messages by the location server 160 and AP 105 corresponding to blocks 420 and 440 and the reception of signals and performing ID verification and location measurements by an AP 105 corresponding to block 435 may be repeated in FIG. 5 when the location server 160 requests NBP location measurements from more than one AP 105.

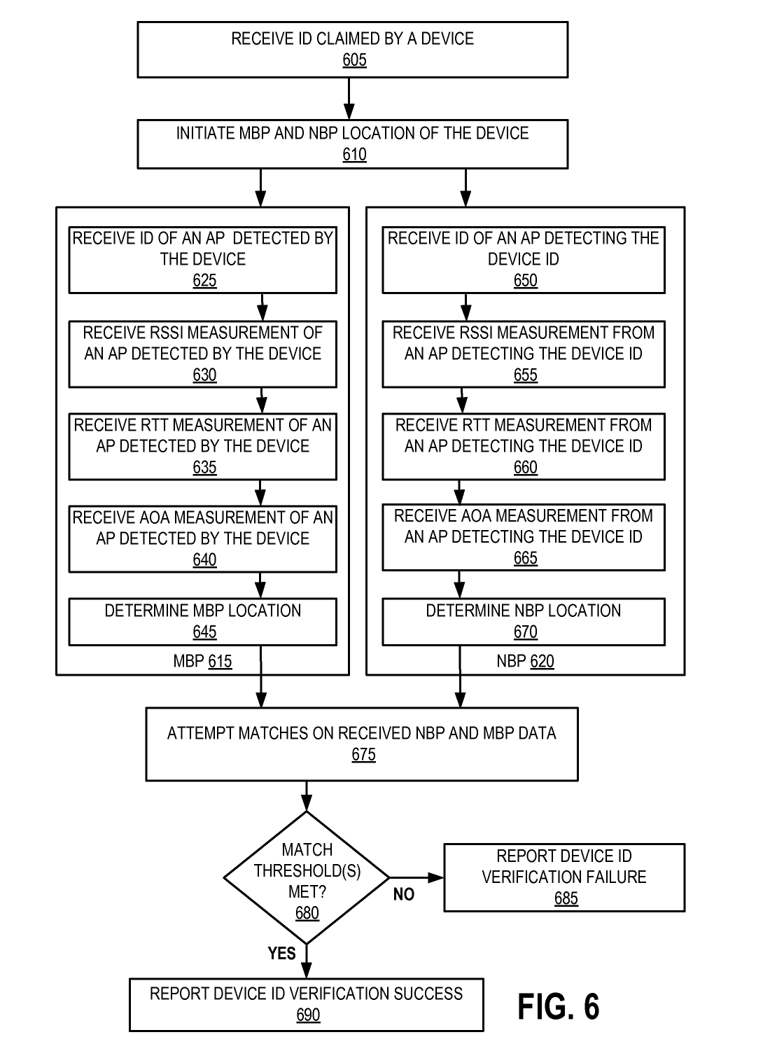

FIG. 6 is a flow diagram illustrating a method for performing WDIV, in another embodiment. The method is exemplified here as being performed by a location server (e.g. location server 160 in FIG. 1 or FIG. 3) but could be performed in whole or in part by another entity such as LBS AS 155 in FIG. 1 and FIG. 3. At block 605, the location server (e.g., a WDIV function in the location server) receives an ID claimed by a wireless device (e.g. target device 110-1 or alternate device 110-2 in FIG. 1 or wireless device 110 in FIG. 3). For example, the location server may receive a request for positioning information from the wireless device that may include the claimed ID. Alternatively, the location server may receive a request for location information (e.g. periodic location or location triggered by the wireless device entering or leaving a geofence) from another entity (e.g. LBS AS 155 in FIG. 1 or FIG. 3) that may include the ID claimed by the wireless device. As another alternative, the location server may be informed (e.g. by an ALN such as ALN 170 in FIG. 3 or by an LBS AS such as LBS AS 155 in FIG. 1 or FIG. 3) that the wireless device has just entered a venue or a specific area of a venue or is registering to receive location services in the venue and may be provided with a device ID claimed by the wireless device. The claimed device ID may be a MAC address of the wireless device in some embodiments.

At block 610, the location server determines to verify the claimed device ID and initiates MBP location of the wireless device at block 615 and NBP location of the wireless device at block 620. Blocks 615 and 620 are composite blocks and each contain component blocks as shown in FIG. 6. In some embodiments, MBP location at block 615 may be skipped if the location server already has recent MBP location measurements received from the wireless device and block 620 may be skipped if the location server already has recent NBP location measurements related to the claimed device ID received (directly or indirectly) from one or more APs in an ALN.

With regards to MBP location at block 615, WDIV at the location server may request the wireless device report measurements for some or all visible APs at blocks 625-645. Visible APs may be APs from which the wireless device detects transmitted frames, messages or other wireless signals that identify the particular AP (e.g. by carrying an ID for the AP). In some embodiments, the wireless device reports visible APs without a request to report from the location server (e.g. if the wireless device is requesting location assistance data from the location server and needs to convey to the location server information about the current location of the wireless device). At block 625, the location server receives an ID (e.g. a MAC address) of an AP detected by the wireless device. In some embodiments, when multiple APs are within range of the wireless device, the location server may receive an ID for each of the APs detected by the wireless device which may be conveyed to the location server by the wireless device in a single message (e.g. a single SUPL, LPP and/or LPPe message).

At block 630, the location server receives an RSSI measurement for an AP detected by the wireless device. In some embodiments, when multiple APs are within range of the wireless device, the location server may receive an RSSI measurement for each of the APs detected by the wireless device (e.g. which may be conveyed in a single message to the location server).

At block 635, the location server receives an RTT measurement for an AP detected by the wireless device. In some embodiments, when multiple APs are within range of the wireless device, the location server may receive an RTT measurement for each of the APs detected by the wireless device (e.g. which may be conveyed in a single message to the location server).

At block 640, the location server receives an AOA measurement for an AP detected by the wireless device. In some embodiments, when multiple APs are within range of the wireless device, the location server may receive an AOA measurement for each of the APs detected by the wireless device (e.g. which may be conveyed in a single message to the location server).

At block 645, the location server may receive additional MBP measurements from the wireless device (e.g. MBP measurements for A-GNSS and/or OTDOA). These additional measurements and/or the measurements received at blocks 625-640 may be used by the location server at block 645 to compute a location estimate for the wireless device. In some embodiments all the measurements for blocks 625-645 may be conveyed by the wireless device to the location server in a single message (e.g. a SUPL, LPP and/or LPPe message) or in a single set of associated messages (e.g. a set of SUPL POS messages for a common SUPL session).

In some embodiments, one or more of blocks 625-645 may not occur—e.g. if the mobile device does not send RSSI, RTT or AOA measurements or if the location server does not compute a location estimate for the wireless device using MBP.

With regards to NBP location at block 620, WDIV at the location server may request one or more APs (e.g. AP 105-1 and/or AP 105-2 in FIG. 1) in an ALN (e.g. ALN 107 in FIG. 3) to verify if the claimed device ID can be detected in signals transmitted by nearby wireless devices and to report measurements (e.g., at blocks 650-665) for the signals if the claimed ID can be detected. In some embodiments, the location server may send the NBP request to each AP individually whereas in other embodiments, the location server may send an NPB request to an intermediate entity such as an ALN controller or router which may then forward the NBP request to one or more APs.

At block 650, the location server receives the ID (e.g. a MAC address) of an AP detecting the device ID. In some embodiments, when multiple APs are within range of the wireless device, the location server may receive a MAC address from each of the APs detecting the device ID. In some embodiments, when more than one AP sends its ID, the IDs may be included in a single message (e.g. by an intermediate entity in the ALN) before being sent to the location server, which may reduce the message load on the location server and the use of signaling resources for the ALN.

At block 655, the location server receives an RSSI measurement from an AP detecting the device ID, measured for a signal received by the AP that contains or is associated with the device ID. In some embodiments, when multiple APs are within range of the wireless device, the location server may receive an RSSI measurement from each of the APs detecting the device ID (e.g. which may all be included in a single message sent by an intermediate entity as in block 650).

At block 660, the location server receives an RTT measurement from an AP detecting the device ID, measured for a signal received by the AP that contains or is associated with the device ID. In some embodiments, when multiple APs are within range of the wireless device, the location server may receive an RTT measurement from each of the APs detecting the device ID (e.g. which may all be included in a single message sent by an intermediate entity as in block 650).

At block 665, the location server receives an AOA measurement from an AP detecting the device ID, measured for a signal received by the AP that contains or is associated with the device ID. In some embodiments, when multiple APs are within range of the wireless device, the location server may receive an AOA measurement from each of the APs detecting the device ID (e.g. which may all be included in a single message sent by an intermediate entity as in block 650). In some embodiments, the measurements received at blocks 650-665 from each AP may be conveyed to the location server in one message from each AP. In some embodiments, the measurements received at blocks 650-665 from all APs may be conveyed to the location server in one message from an intermediate entity in the ALN.

At block 670, the location server may compute a location estimate for the wireless device using NBP, based on one or more of the measurements received at blocks 650-665 and possibly additional NBP measurements received from APs such as measurements of TOA or TDOA.

In some embodiments, one or more of blocks 650-670 may not occur—e.g. if APs do not send RSSI, RTT or AOA measurements or if the location server does not compute a location estimate for the wireless device using NBP.

At block 675, the location server or a WDIV function in the location server attempts to match the MBP data obtained at block 615 with the NBP data obtained at block 620. In one embodiment, the location server verifies whether the IDs of APs reported by the wireless device at block 625 match the IDs of APs that reported detecting the claimed device ID at block 650. The location server may not require that all AP IDs that are reported for MBP and NBP can be matched but may require that some minimum number can be matched or that the reported IDs for MBP and NBP belong to APs in the same local area (e.g. a sub-area for a venue such as the same floor in a building or same terminal at an airport). The location server may also verify whether the received RSSI, AOA and RSSI measurements and the obtained wireless device location at blocks 630-645 for MBP match or are consistent with the received RSSI, AOA and RSSI measurements and the obtained wireless device location at blocks 655-670 for MBP. Verification of consistency may be as described earlier herein and in association with FIG. 1, FIG. 2B and FIG. 3. The location server may further verify that the received NBP (and possibly MBP) measurements are self consistent as described earlier in association with block 445 in FIG. 4 and in association with scenario 3 described for FIG. 1.

At block 680, the location server determines whether the threshold(s) are met for matching and/or verifying consistency of the MBP data and NBP data at block 675. For example an AP threshold match may require a match of at least 70% or some other percent/number of the IDs of APs detecting the claimed device ID at block 650 to the IDs of APs reported by the wireless device at block 625 before a claimed device ID may be considered verified. As another example, an RTT threshold match may require that RTT measurements provided by APs at block 660 imply a distance (or range) from each AP to the wireless device that is within 25 meters (or some other maximum length) of the distance (or range) from the wireless device to each corresponding AP implied by RTT measurements provided by the wireless device at block 635, for some minimum number of APs. As another example of RSSI and AOA matching thresholds, the location server may verify that pairs of reported NBP and MBP AOAs for an AP detecting the device ID and being detected by the wireless device, respectively, are within a predetermined variation threshold (e.g., 20% or some other percentage) of one another, after allowing for AOAs being in opposite directions for NBP versus MBP, and that normalized MBP and NBP RSSI measurements are correlated. For example, if a wireless device RSSI measurement of a first AP is higher than for a second AP when normalized with respect to AP transmission power, then the first AP's RSSI measurement for the wireless device may be verified to exceed the second AP's RSSI measurement for the wireless device. The level of required threshold match for the different measurements may be adjustable by the location server of by an operator of a venue, for example, depending on the particular security requirements of a venue or location. Threshold matching may also require that the wireless device provide at least some MBP measurements at block 615 and that at least some APs provide NBP measurements at block 620. Thus, for example, if the wireless device cannot be accessed by the location server (e.g. due to being outside the venue, powered off or not in radio coverage) or is otherwise unable to provide any MBP measurements, the location server can conclude that a threshold requirement is not matched. Similarly, if no APs in the venue report detecting the wireless device (e.g. because the wireless device is not in the venue or is powered down or the user has disabled Wi-Fi capability), the location server can conclude that a threshold requirement is not matched. Note that other thresholds may be used to verify self consistency of NBP (and MBP) measurements. For example, there may be a maximum threshold on the distance between two APs that report receiving the device ID in order for the NBP measurements to be considered as self-consistent.

If the thresholds are not met, at block 685 the location server reports the device ID verification failure. In some embodiments, in response to device ID verification failure, the location server and/or other entities associated with the location server (e.g. an LBS AS) deny a wireless device access to LBS services and/or other service provided by or on behalf of a venue.

If the thresholds are met, at block 690 the location server reports the device ID verification success. In some embodiments, in response to device ID verification success, the location server and/or other associated entities (e.g. an LBS AS) provide LBS and/or other services to the wireless device and may use NBP location in order to provide LBS services—e.g. to obtain one or more locations for the wireless device and provide these to the wireless device and/or to other authorized entities. In some embodiments, in response to verifying a device ID, the location server may initiate a timeout period during which no further retesting of the device ID would occur. Following the timeout period, if the wireless device may still be within a venue associated with the location server, the location server may re-verify the device ID by repeating blocks 610 to 690. In some embodiments, the location server may periodically verify device ID credibility with the frequency depending on the particular security requirements set by the venue or location.

It should be noted that for the method described herein (e.g. in association with FIGS. 1-6), three specific MBP and NBP measurements, comprising RSSI, RTT and AOA, have been primarily identified as being usable to verify an ID claimed by a wireless device. However, other NBP and MBP measurements and other location data that relate to the relative locations of an AP and a wireless device may be used in addition or instead. Examples of such other measurements and other location data include a serving cell ID(s) (or serving base station or femtocell ID(s)) and/or other visible cell IDs (or visible base station or femtocell IDs) for a wireless device (in the case that the wireless device has cellular access or cellular capability), signal quality (e.g. signal to noise ratio (S/N)), signal angle of departure (AOD) from a transmitter, signal time of arrival (TOA—e.g. as measured relative to some absolute time such as Coordinated Universal Time (UTC) or GPS time) and relative location coordinates (e.g. where a wireless device location is given by X, Y and possibly Z coordinates relative to an AP location or vice versa). In addition, the method described here has so far mainly focused on comparing like NBP and MBP measurements for corresponding APs rather than different NBP and MBP measurements for corresponding APs or like (or different) MBP and NBP measurements for different APs. Thus, in an extension of the method so far described, a location server may verify consistency of NBP and MBP measurements that: (A) include other measurements such as serving cell ID (or serving base station or femtocell ID), visible cell IDs (or visible base station or femtocell IDs), S/N, AOD, TOA and/or relative X,Y (and Z) location coordinates; (B) involve comparing different NBP and MBP measurements; and (C) are for non-corresponding APs. As an example of (A), a wireless device may provide MBP measurements of S/N and/or AOD to an LS for signals received from an AP and the AP may provide NBP measurements of S/N and/or AOD to the LS for signals received that carry or are associated with device ID claimed by the wireless device. The LS may then verify that the two S/N measurements are consistent (e.g. each imply the same or similar range from the AP to the wireless device) and/or that the two AOD measurements define directions that are opposite or nearly opposite—which may be used as evidence that the claimed device ID is valid. As an example of (B), a wireless device may provide MBP measurements of RSSI and AOD to an LS for signals received from an AP and the AP may provide NBP measurements of RTT and AOA to the LS for signals received that carry or are associated with device ID claimed by the wireless device. The LS may then verify that the RSSI and RTT measurements are consistent (e.g. each imply the same or similar range from the AP to the wireless device) and that the AOD and AOA measurements define directions that are the same or nearly the same—which may be used as evidence that the claimed device ID is valid. As an example of (C), a wireless device may provide MBP measurements of RSSI and RTT to an LS for signals received from a first AP and a second AP nearby to the first AP may provide NBP measurements of RSSI and S/N to the LS for signals received that carry or are associated with the device ID claimed by the wireless device. The LS may then verify that the two RSSI measurements and the RTT and S/N measurements are consistent with one another (e.g. each imply a similar range between the first or second AP and the wireless device) within the limits imposed by the distance between the first and second APs. For example, if this distance is known to be 10 meters, the LS may verify that MBP RSSI and RTT measurements imply a range of X meters between the wireless device and the first AP while the NBP RSSI and S/N measurements imply a range of Y meters from the second AP to the wireless device. If X and Y are within 10 meters of one another (or within some value slightly greater than this to allow for errors in measurements and range determination), the LS may consider that the NBP and MBP measurements are consistent, which may be used as evidence that the claimed device ID is valid.

It should further be noted that while the method described herein has been mainly described in terms of verifying an IEEE 802.11 MAC address for a wireless device receiving location services in a venue, the same or similar methods may be used in other scenarios for verifying any identity or address used by or claimed by a wireless device in association with a particular wireless technology (e.g. Bluetooth, Near Field Communication, WCDMA, LTE) within a venue or within a larger area such as town, city, state, country or worldwide. This verification may be desirable in scenarios where the wireless device includes the address or identity in messages or signals transmitted using the particular wireless technology to nearby access points, base stations or femtocells in a network wherein the access points, base stations or femtocells are able to receive, demodulate and decode the identity or address. In these scenarios, the wireless device or some other entity may transfer a claimed or assumed identity or address for the wireless device to one or more servers in a network from which the wireless device or the other entity is receiving service and may request various services from the one or more servers that may depend on the identity or address correctly belonging to the wireless device and not to some other wireless device. For example, the services may include locating the wireless device by the one or more servers using NBP and transferring the resulting location to the wireless device or to the other entity. Or the services may include provision of other information for which the wireless device has some subscription or is otherwise entitled to receive (e.g. such as provision of Internet access, ability to send and receive voice or data calls, receipt of other information). By matching information obtained from base stations, femtocells and/or APs based on receipt of messages or signals carrying the claimed or assumed identity or address with similar or corresponding information provided by the wireless device directly to a server (such as a location server), a server or network (e.g. a location server in the network) may verify the probable integrity of the claimed or assumed identity or address.

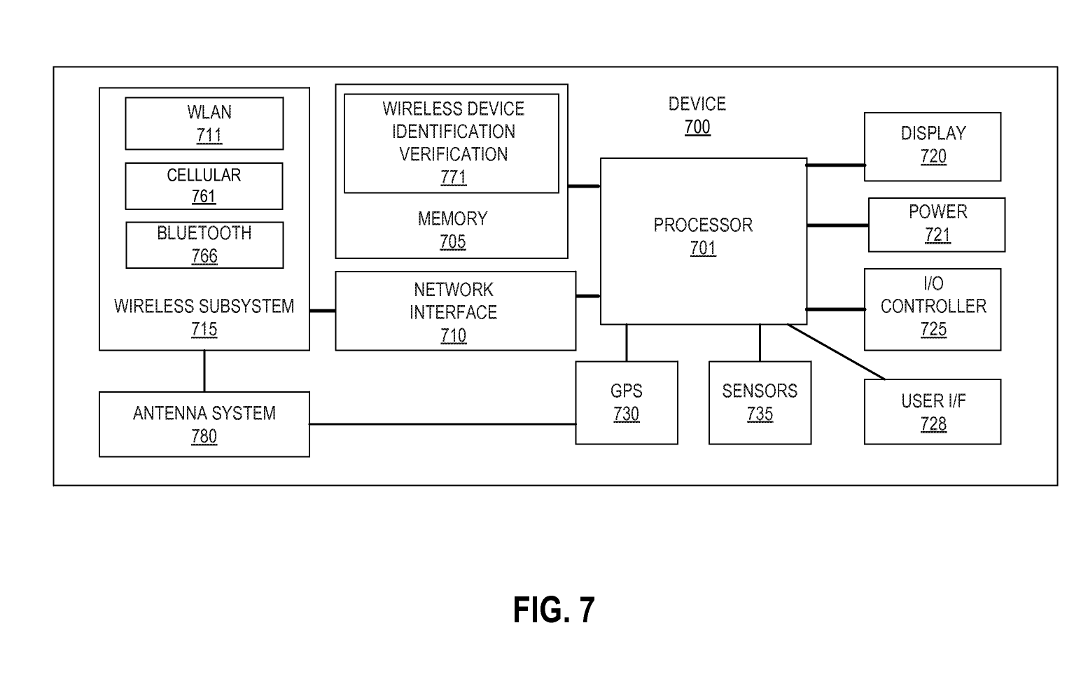

FIG. 7 is block diagram illustrating an exemplary wireless device 700 in which embodiments of Wireless Device Identification verification may be practiced. The wireless device 700 may correspond to or represent any of wireless devices 110-1 and 110-2 in FIG. 1 and wireless device 110 in FIG. 3 and may support the WDIV method embodiments described in association with FIGS. 2A, 4, 5 and/or 6. Wireless device 700 may include one or more processors 701 (e.g., a general purpose processor, specialized processor, or digital signal processor), a memory 705, I/O controller 725, and network interface 710. It should be appreciated that wireless device 700 may also include a display 720, a user interface (I/F) 728 (e.g., keyboard, touch-screen, or similar wireless devices), a power device 721 (e.g., a battery), as well as other components typically associated with electronic devices. In some embodiments, wireless device 700 may be a mobile or non-mobile device.

The wireless device 700 may also include a number of wireless device sensors 735 coupled to one or more buses or signal lines further coupled to the processor(s) 701. The sensors 735 may include a clock, ambient light sensor (ALS), accelerometer, gyroscope, magnetometer, temperature sensor, barometric pressure sensor, red-green-blue (RGB) color sensor, ultra-violet (UV) sensor, UV-A sensor, UV-B sensor, compass, proximity sensor. The wireless device may also include a Global Positioning System (GPS) or GNSS receiver 730 which may enable GPS or GNSS measurements in support of A-GNSS positioning. In some embodiments, multiple cameras are integrated or accessible to the wireless device. In some embodiments, other sensors may also have multiple versions or types within a single wireless device.

Memory 705 may be coupled to processor 701 to store instructions (e.g., instructions to perform WDIV 771) for execution by processor 701. In some embodiments, memory 705 is non-transitory. Memory 705 may also store software or firmware instructions (e.g. for one or more programs or modules) to implement embodiments described herein such as WDIV embodiments described in association with FIGS. 1-6. Thus, the memory 705 is a processor-readable memory and/or a computer-readable memory that stores software code (programming code, instructions, etc.) configured to cause the processor 701 to perform the functions described herein. Alternatively, one or more functions of WDIV may be performed in whole or in part in device hardware.

Memory 705 may also store data from integrated or external sensors. In addition, memory 705 may store application program interfaces (APIs) for accessing WDIV. In some embodiments, WDIV functionality can be implemented in memory 705. In other embodiments, WDIV functionality can be implemented as a module separate from other elements in the wireless device 700. The WDIV module may be wholly or partially implemented by other elements illustrated in FIG. 7, for example in the processor 701 and/or memory 705, or in one or more other elements of the wireless device 700.

Network interface 710 may also be coupled to a number of wireless subsystems 715 (e.g., Bluetooth 766, WLAN 711, Cellular 761, or other networks) to transmit and receive data streams through a wireless antenna system 780 to/from a wireless network or through a wired interface for direct connection to networks (e.g., the Internet, Ethernet, or other wireline systems). Wireless subsystems 715 may be connected to antenna system 780. Antenna system 780 may be connected to GPS or GNSS receiver 730 to enable reception of GPS or other GNSS signals by GPS or GNSS receiver 730. Antenna system 780 may comprise a single antenna, multiple antennas and/or an antenna array and may include antennas dedicated to receiving and/or transmitting one type of signal (e.g. cellular, Wi-Fi or GNSS signals) and/or may include antennas that are shared for transmission and/or reception of multiple types of signals. WLAN subsystem 711 may comprise suitable devices, hardware, and/or software for communicating with and/or detecting signals from Wi-Fi APs and/or other wireless devices within a network (e.g. femtocells). In one aspect, WLAN subsystem 711 may comprise a Wi-Fi (802.11x) communication system suitable for communicating with one or more wireless access points.

Cellular subsystem 761 may include one or more wide area network transceiver(s) that may be connected to one or more antennas in antenna system 780. The wide area network transceivers may comprise suitable devices, hardware, and/or software for communicating with and/or detecting signals to/from other wireless devices within a network. In one aspect, the wide area network transceivers may comprise a CDMA communication system suitable for communicating with a CDMA network of wireless base stations; however in other aspects, the wide area network transceivers may support communication with other cellular telephony networks or femtocells, such as, for example, TDMA, LTE, Advanced LTE, WCDMA, UMTS, 4G, or GSM. Additionally, any other type of wireless networking technologies may be supported and used by wireless device 700, for example, WiMax (802.16), Ultra Wide Band, ZigBee, wireless USB, etc. In conventional digital cellular networks, position location capability can be provided by various time and/or phase measurement techniques. For example, in CDMA networks, one position determination approach used is Advanced Forward Link Trilateration (AFLT). Using AFLT, a server may compute a position for wireless device 700 from phase measurements made by wireless device 700 of pilot signals transmitted from a plurality of base stations.

The wireless device as used herein (e.g., wireless device 700, wireless device 110) may be a: wireless device, cell phone, personal digital assistant, mobile computer, wearable device (e.g., watch, head mounted display, virtual reality glasses, etc.), tablet, personal computer, laptop computer, or any type of device that has wireless capabilities. As used herein, a wireless device may be any portable, or movable device or machine that is configurable to acquire wireless signals transmitted from, and transmit wireless signals to, one or more wireless communication devices or networks. Thus, by way of example but not limitation, the wireless device 700 may include a radio device, a cellular telephone device, a computing device, a personal communication system device, or other like movable wireless communication equipped device, appliance, or machine. The term “wireless device” is also intended to include devices which communicate with a personal navigation device, such as by short-range wireless, infrared, wireline connection, or other connection—regardless of whether satellite signal reception, assistance data reception, and/or position-related processing occurs at the device 700. Also, the term “wireless device” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the wireless device, at a server, or at another wireless device associated with the network. Any operable combination of the above can also be considered a “wireless device” as used herein. Other uses may also be possible. While various examples given in the description below relate to wireless devices, the techniques described herein can be applied to any wireless device for which accurate context inference is desirable.

In one embodiment, the wireless device (e.g., wireless device 700) is capable of monitoring the context of a user within close proximity (e.g. mobile phone) or the wireless device may be physically attached to the user (e.g., watch, wrist band, necklace or other wearable wireless device). In one example, a user (e.g., children, elderly people, patients suffering from physical or mental health ailments, etc.) may carry the wireless device while performing normal day to day activities. In some embodiments, the wireless device may be at a patient's bedside, worn by the elderly within their home, an anklet may be attached to a confined person, or any number of other implementations and use cases are possible.

The wireless device may communicate wirelessly with a plurality of APs, base stations and/or femtocells using RF signals (e.g., 700 MHz, 1900 MHz, 2.4 GHz, 3.6 GHz, and 4.9/5.0 GHz bands) and standardized protocols for the modulation of the RF signals and the exchanging of information. For example, the protocol may be Institute of Electrical and Electronics Engineers (IEEE) 802.11x or 3GPP LTE. By extracting different types of information from the exchanged signals, and utilizing the layout of the network (i.e., the network geometry) the wireless device may determine its position within a predefined reference coordinate system.

It should be appreciated that embodiments of the invention as will be hereinafter described may be implemented through the execution of instructions, for example as stored in the memory 705 or other element, by processor 701 of wireless device 700 and/or other circuitry of wireless device 700 and/or other wireless devices. Particularly, circuitry of wireless device 700, including but not limited to processor 701, may operate under the control of a program, routine, or the execution of instructions to execute methods or processes in accordance with embodiments of the invention. For example, such a program may be implemented in firmware or software (e.g. stored in memory 705 and/or other locations) and may be implemented by processors, such as processor 701, and/or other circuitry of wireless device 700. Further, it should be appreciated that the terms processor, microprocessor, circuitry, controller, etc., may refer to any type of logic or circuitry capable of executing logic, commands, instructions, software, firmware, functionality and the like.

Some or all of the functions, engines or modules described herein (e.g., WDIV) may be performed by the wireless device 700 itself and/or some or all of the functions, engines or modules described herein may be performed by another system connected through I/O controller 725 or network interface 710 (wirelessly or wired) to the wireless device. Thus, some and/or all of the functions may be performed by another system and the results or intermediate calculations may be transferred back to the wireless device. In some embodiments, such other device may comprise a server configured to process information in real time or near real time. In some embodiments, the other device is configured to predetermine the results, for example based on a known configuration of the device. Further, one or more of the elements illustrated in FIG. 7 may be omitted from the wireless device 700. For example, one or more of the sensors 735 may be omitted in some embodiments.

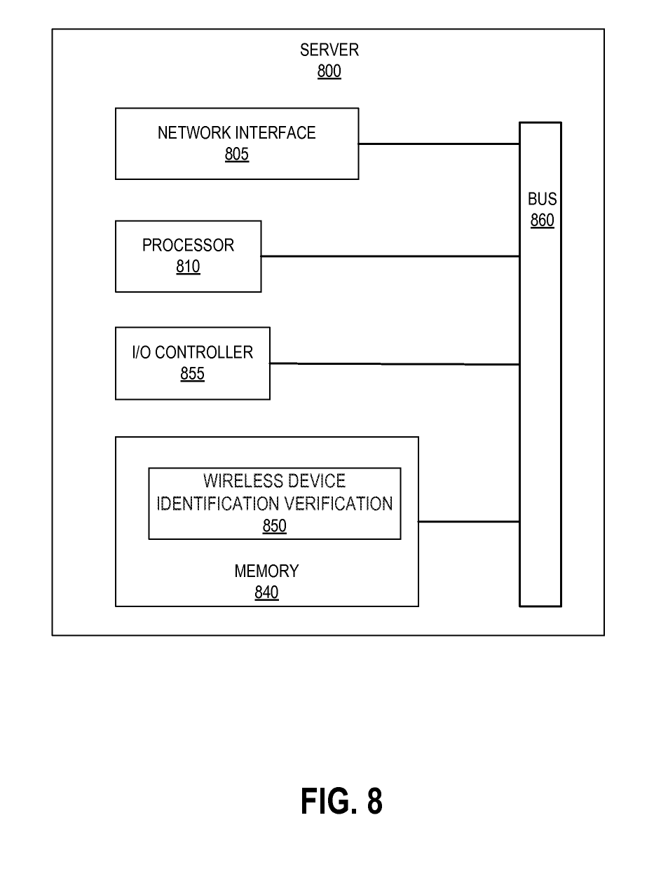

FIG. 8 is block diagram illustrating an exemplary server 800 in which embodiments of the invention may be practiced. Server 800 may correspond to or represent any of location server 160 in FIGS. 1 and 3 and AS or LBS AS 155 in FIGS. 1 and 3. For the sake of simplicity, the various features and functions illustrated in the box diagram of FIG. 8 are connected together using a common bus 860 meant to represent that these various features and functions are operatively coupled together. Those skilled in the art will recognize that other connections, mechanisms, features, functions, or the like, may be provided and adapted as necessary to operatively couple and configure a data processing system (e.g., server 800). Further, it is also recognized that one or more of the features or functions illustrated may be further subdivided or combined.

The server 800 may include a network interface 805 configured to communicate with a network (not shown), which may be configured to communicate with other servers, computers, and devices (e.g., wireless device 110).

A processor 810 may be connected to the network interface 805 via the bus 860, and a memory 840. The processor 810 may include one or more microprocessors, microcontrollers, and/or digital signal processors that provide processing functions, as well as other calculation and control functionality. The memory 840 may contain software and/or firmware containing instructions (e.g. in the form of programs or modules) that enable server 800 (e.g. the processor 810) to perform the various embodiments described herein, such as those described in association with FIGS. 1-6. The memory 840 can store data as well as software instructions for executing programmed functionality within the server. The memory 840 may be on-board the processor 810 (e.g., within the same IC package), and/or the memory may be external memory to the processor and functionally coupled over a data bus. The details of software functionality associated with aspects of the disclosure will be discussed in more detail below. The memory may comprise RAM, DRAM, SRAM, PROM, EPROM and may include secondary memory such as provided by a disk drive.

A number of software modules or data tables may reside in memory 840 and may be utilized by the processor 810 in order to manage communications, and WDIV functionality. As illustrated in FIG. 8, memory 840 may include instructions and data for the WDIV function 850. One should appreciate that the organization of the memory contents as shown in FIG. 8 is merely exemplary, and as such the functionality of the modules and/or data structures may be combined, separated, and/or be structured in different ways depending upon the implementation of the device. In one embodiment, WDIV 850 may be a process running on the processor 810 of the server 800, which provides for enhanced data collection.

The server 800 may optionally store auxiliary position/motion data in memory 840 that may be derived from information received from various sources such as APs (e.g. AP 105-1 or AP 105-2 in FIG. 1) and wireless devices (e.g. wireless device 110 in FIG. 3). Moreover, in other embodiments, supplemental information may include, but not be limited to, information that can be derived or based upon Wi-Fi signals, Bluetooth signals, beacons, RFID tags, and/or information derived from a map (e.g., receiving coordinates from a digital representation of a geographical map by, for example, a user interacting with a digital map).

The network interface 805 may enable server 800 to send and receive information to and from external networks (e.g. network 150 in FIG. 1 or ALN 170 in FIG. 3), Network interface 805 may support communication between server 800 and APs (e.g. APs 105-1 and 105-2 in FIG. 1 and APs in ALN 107 in FIG. 3) and networks (e.g. network 150 in FIG. 1) including cellular networks (e.g. WCDMA and LTE networks) and wireline networks (e.g. the Internet). Network interface 805 may also support communication between server 800 and one or more devices or wireless devices (which may be transferred via one or more intermediate networks such as network 150 in FIG. 1) including target device 110-1 and alternative device 110-2 in FIG. 1 and wireless device 110 in FIG. 3. Network interface 805 may support communication with wireless devices using protocols such as ULP, LPP and/or LPPe.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, WDIV may be implemented as a software, firmware, hardware, module, or engine. In one embodiment, the previous WDIV description may be implemented by one or more general purpose processors (e.g., 810) in memory 840 of server 800 to achieve the previously desired functions (e.g., the method embodiments of FIGS. 2A, 2B, 4, 5, and 6). If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

Aspects of WDIV are disclosed in the above description and related drawings and are directed to specific embodiments. Alternate embodiments may be devised without departing from the scope of the embodiments described herein. Additionally, well-known elements of the embodiments described herein may not be described in detail or may be omitted so as not to obscure relevant details.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device (e.g., a server or device). It will be recognized that various actions described herein can be performed by specific circuits (e.g., application specific integrated circuits), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for verifying an identity (ID) claimed by a wireless device, the method comprising:
receiving the ID from the wireless device;
receiving a first measurement from the wireless device;
receiving a second measurement from a trusted access point (AP), wherein the second measurement is of a signal comprising the ID; and
verifying the ID by verifying consistency of the first and second measurements.

2. The method of claim 1 wherein the ID is an Institute of Electrical and Electronics Engineers (IEEE) 802.11 media access control (MAC) address.

3. The method of claim 2, wherein:
the first measurement comprises a first MAC address,
the second measurement comprises a second MAC address, and
the verifying consistency comprises verifying the first MAC address is the MAC address of the trusted AP and the second MAC address is the ID.

4. The method of claim 3, wherein:
the first measurement further comprises one or more of: a first Received Signal Strength Indication (RSSI), a First Angle Of signal Arrival (AOA) and a first Round Trip propagation Time (RTT) associated with an AP having the first MAC address,
the second measurement further comprises one or more of: a second RSSI, a second AOA and a second RTT determined from at least one signal comprising the ID, and
the verifying consistency further comprises determining the first RSSI, the first AOA or the first RTT corresponds, respectively, with the second RSSI, the second AOA or the second RTT within a correspondence threshold.

5. The method of claim 4, wherein the correspondence threshold comprises one or more of: equality, similarity, opposition or correlation of the first and second RSSI, AOA or RTT values.

6. The method of claim 1, wherein:
the first measurement is a mobile based positioning (MBP) location result, and the second measurement is a network based positioning (NBP) location result.

7. The method of claim 1, wherein:
the first measurement comprises, or is used to determine, a first location of the wireless device,
the second measurement comprises, or is used to determine, a second location of the wireless device, and
the verifying consistency further comprises determining the first and second locations are within at least a threshold distance to each other.

8. A server for verifying an identity (ID) claimed by a wireless device, the server comprising:
memory; and
a processor coupled to the memory and configured to:
receive the ID from the wireless device;
receive a first measurement from the wireless device;
receive a second measurement from a trusted access point (AP), wherein the second measurement is of a signal comprising the ID; and
verify the ID by verifying consistency of the first and second measurements.

9. The server of claim 8 wherein the ID is an Institute of Electrical and Electronics Engineers (IEEE) 802.11 media access control (MAC) address.

10. The server of claim 9, wherein:
the first measurement comprises a first MAC address,
the second measurement comprises a second MAC address, and
the verifying consistency comprises verifying the first MAC address is the MAC address of the trusted AP and the second MAC address is the ID.

11. The server of claim 10, wherein:
the first measurement further comprises one or more of: Received Signal Strength Indication (RSSI), a first Angle of signal Arrival (AOA), a first Round Trip propagation Time (RTT) associated with an AP having the first MAC address, or any combination thereof,
the second measurement further comprises one or more of: a second RSSI, a second AOA, a second RTT determined from at least one signal comprising the ID, or any combination thereof, and
the verifying consistency further comprises determining the first RSSI, first AOA, or first RTT corresponds, respectively, with the second RSSI, the second AOA, or the second RTT within a correspondence threshold.

12. The server of claim 11, wherein the correspondence threshold comprises one or more of: equality, similarity, opposition, or correlation of the first and second RSSI, AOA, or RTT values.

13. The server of claim 8, wherein:
the first measurement is a mobile based positioning (MBP) location result, and
the second measurement is a network based positioning (NBP) location result.

14. The server of claim 8, wherein:
the first measurement comprises, or is used to determine, a first location of the wireless device,
the second measurement comprises, or is used to determine, a second location of the wireless device, and
the verifying consistency further comprises determining the first and second locations are within at least a threshold distance to each other.

15. A machine readable non-transitory storage medium having stored therein program instructions that are executable by a processor to:
receive an Identification (ID) from a wireless device;
receive a first measurement from the wireless device;
receive a second measurement from a trusted access point (AP), wherein the second measurement is of a signal comprising the ID; and
verify the ID by verifying consistency of the first and second measurements.

16. The storage medium of claim 15 wherein the ID is an Institute of Electrical and Electronics Engineers (IEEE) 802.11 media access control (MAC) address.

17. The storage medium of claim 16, wherein:
the first measurement comprises a first MAC address, the second measurement comprises a second MAC address, and the instructions to verify consistency further comprises instructions to verify the first MAC address is the MAC address of the trusted AP and the second MAC address is the ID.

18. The storage medium of claim 17, wherein:
the first measurement further comprises one or more of: Received Signal Strength Indication (RSSI), a first Angle of signal Arrival (AOA), a first Round Trip propagation Time (RTT) associated with an AP having the first MAC address, or any combination thereof,
the second measurement further comprises one or more of: a second RSSI, a second AOA, a second RTT determined from at least one signal comprising the ID, or any combination thereof, and
the instructions to verify consistency further comprises instructions to determine the first RSSI, first AOA, or first RTT corresponds, respectively, with the second RSSI, the second AOA, or the second RTT within a correspondence threshold.

19. The storage medium of claim 18, wherein the correspondence threshold comprises one or more of: equality, similarity, opposition, or correlation of the first and second RSSI, AOA, or RTT values.

20. The storage medium of claim 15, wherein:
the first measurement is a mobile based positioning (MBP) location result, and
the second measurement is a network based positioning (NBP) location result.

21. The storage medium of claim 15, wherein:
the first measurement comprises, or is used to determine, a first location of the wireless device,
the second measurement comprises, or is used to determine, a second location of the wireless device, and
the instructions to verify consistency further comprises instructions to determine the first and second locations are within at least a threshold distance to each other.

22. An apparatus to verify an identity (ID) claimed by a wireless device comprising:
means for receiving the ID from the wireless device;
means for receiving a first measurement from the wireless device;
means for receiving a second measurement from a trusted access point (AP), wherein the second measurement is of a signal comprising the ID; and
means for verifying the ID by verifying consistency of the first and second measurements.

23. The apparatus of claim 22 wherein the ID is an Institute of Electrical and Electronics Engineers (IEEE) 802.11 media access control (MAC) address.

24. The apparatus of claim 23, wherein:
the first measurement comprises a first MAC address,
the second measurement comprises a second MAC address, and
the means for verifying consistency comprises verifying the first MAC address is the MAC address of the trusted AP and the second MAC address is the ID.

25. The apparatus of claim 24, wherein:
the first measurement further comprises one or more of: Received Signal Strength Indication (RSSI), a first Angle of signal Arrival (AOA), a first Round Trip propagation Time (RTT) associated with an AP having the first MAC address, or any combination thereof,
the second measurement further comprises one or more of: a second RSSI, a second AOA, a second RTT determined from at least one signal comprising the ID, or any combination thereof, and
the means for verifying consistency further comprises determining the first RSSI, first AOA, or first RTT corresponds, respectively, with the second RSSI, the second AOA, or the second RTT within a correspondence threshold.

26. The apparatus of claim 25, wherein the correspondence threshold comprises one or more of: equality, similarity, opposition, or correlation of the first and second RSSI, AOA, or RTT values.

27. The apparatus of claim 22, wherein:
the first measurement is a mobile based positioning (MBP) location result, and
the second measurement is a network based positioning (NBP) location result.

28. The apparatus of claim 22, wherein:
the first measurement comprises, or is used to determine, a first location of the wireless device,
the second measurement comprises, or is used to determine, a second location of the wireless device, and
the means for verifying consistency further comprises determining the first and second locations are within at least a threshold distance to each other.
